(19) United States
(12) Patent Application Publication
(10) Pub. No.: US 2019/0057464 A1
(43) Pub. Date: Feb. 21, 2019

(54) Systems and methods for constructing and indexing a rule based offer database

(71) Applicant: Direct Booking LLP, Marrakesh (MA)

(72) Inventors: Pierre Alexis Chapoutot, Marrakech (MA); Yazan Osama Takriti, Marrakech (MA)

(73) Assignee: Direct Booking LLP

(21) Appl. No.: 15/998,522

(22) Filed: Aug. 16, 2018

Related U.S. Application Data
(60) Provisional application No. 62/546,607, filed on Aug. 17, 2017.

(51) Int. Cl. G06Q 50/12; G06F 17/30; G06Q 30/02; G06Q 30/06; G06Q 10/02

(52) U.S. Cl. CPC G06Q 50/12; G06F 17/30321; G06F 17/3056; G06F 17/30867; G06F 3/0482; G06Q 30/0235; G06Q 30/0223; G06Q 30/0627; G06Q 10/02; G06F 17/3053

(57) ABSTRACT

The present disclosure relates to systems and methods for constructing and indexing a rule-based offer database and for generating personalized search results using the same. In one implementation, to construct the database, at least one processor may receive a date rule specifying a start date and an end date, receive a rate rule relating one or more room types to one or more rates, receive a services rule relating one or more services to one or more prices, receive one or more conditions for coupling to the services rule, and construct the database by: associating the one or more conditions with the services rule to generate service entities, linking the date rule to the service entities, associating rates of the rate rule to room types of the rate rule to generate room entities, linking the date rule to the room entities, linking the one or more service entities to the one or more room entities, and indexing the date rule for offer generation.

### CROSS-REFERENCE TO RELATED APPLICATIONS

The present application claims the benefit of priority of U.S. Provisional Patent Application No. 62/546,607, filed on Aug. 17, 2017. The foregoing application is incorporated herein by reference in its entirety.

### TECHNICAL FIELD

The present disclosure relates generally to the field of database construction, indexing and use. More specifically, and without limitation, this disclosure relates to systems and methods for constructing and indexing a rule-based offer database and automatically generating personalized offers therefrom.

### BACKGROUND

In the hotel industry, booking often occurs directly through the hotel or through a stock aggregator such as a Booking Holdings website, an Expedia Group™ website, or the like. When booking directly through the hotel, predefined room rates and standard offers may be obtained through the hotel's website, or a consumer may telephone the hotel to negotiate extra services, such as breakfast, spa treatments, airport transport, or the like to include in the consumer's reservation). However, such negotiations are manually and take place person-to-person over the phone. The manual nature of such negotiations also limits them to a single hotel at a time; moreover, studies show that people prefer not to negotiate in person. Accordingly, hotels have high customer acquisition costs, and approximately 98% of website visitors may not book directly with the hotel, absent a compelling reason.

Automated aggregators allow a consumer to search multiple hotels at a time. However, such services generally use a global hotel inventory system and therefore provide simple rates with room types. Accordingly, unlike the manual negotiations described above, no extra services are provided to entice consumers to finalize a reservation. Indeed, on aggregators, hotel rooms are fully commoditized such that price and location are the only differentiators.

### SUMMARY

In view of the foregoing, embodiments of the present disclosure describe systems and methods for constructing and indexing a rule-based offer database. The rule-based offer database may be used to provide automated offers personalized to a user and including extra services selected by the user. Accordingly, embodiments of the present disclosure provide an improvement over manual techniques for negotiating with a hotel and over automated techniques that rely only on global inventory and do not provide extra services or personalization.

Moreover, embodiments of the present disclosure describe systems and methods for generating graphical user interfaces (GUIs) for constructing and indexing the rule-based offer database and for using the same. The GUIs include particular structures to ease a user's experience in populating the database and searching the database. In particular, the GUIs provide graphically-based selectors to improve the user's interaction with the rule-based offer database over conventional approaches, which are generally textual.

In one embodiment, the present disclosure describes a system for constructing and indexing a rule-based offer database. The system may comprise at least one memory storing instructions and at least one processor configured to execute the instructions to perform one or more operations. The one or more operations may comprise: receiving a date rule specifying a start date and an end date; receiving a rate rule relating one or more room types to one or more rates; receiving a services rule relating one or more services to one or more prices; receiving one or more conditions for coupling to the services rules; and constructing the rule-based offer database. The at least one processor may construct the rule-based offer database by associating the one or more conditions with the services rule to generate one or more service entities, linking the date rule to the one or more service entities, associating rates of the rate rule to room types of the rate rule to generate one or more room entities, linking the date rule to the one or more room entities, and indexing the date rule for offer generation.

In one embodiment, the present disclosure describes a system for generating personalized search results using a rule-based offer database. The system may comprise at least one memory storing instructions and at least one processor configured to execute the instructions to perform one or more operations. The one or more operations may comprise: receiving one or more favorite services from a user; receiving a start date and an end date from the user; receiving a capacity and a number of rooms from the user; selecting stock using the rule-based offer database; selecting services using the rule-based offer database; generating one or more offers that match the one or more rooms with the ranked services; calculating disparities between prices of the one or more rooms and the ranked services and rates retrieved from the rule-based offer database; and generating a user interface with a ranked list of the generated offers that allows the user to select an offer from the generated offers. The at least one processor may select stock by mapping the start date and the end date onto one or more date rules including both the start date and the end date and mapping the capacity and the number of rooms onto one or more rooms. The at least one processor may select services by mapping the one or more favorite services onto one or more services of the rule-based offer database, selecting a subset of the one or more services for which one or more conditions are met, and ranking the subset based on a priority input by the user.

In one embodiment, the present disclosure describes a system for generating interfaces for searching a rule-based offer database. The system may comprise at least one memory storing instructions and at least one processor configured to execute the instructions to perform one or more operations. The one or more operations may comprise: generating a first user interface displaying a plurality of graphics, each graphic being associated with a service and being selectable; transmitting the first user interface to a display associated with a user; receiving, based on interaction with the first user interface, a selection of one or more services from the user; and in response to the selection of services, generating a second user interface. The second user interface may have a text box for entry of a location or a hotel name, a first date selector for entry of a start date, a second date selector for entry of an end date, a first selector for capacity, and a second selector for a number of rooms. The one or more operations may further comprise transmitting the second user interface to the display; receiving, based on interaction with the second user interface, the location, the start date, the end date, the capacity, and the number of rooms; in response to receiving the location, the start date, and the end date, generating a query based on the selection, the location or the hotel name, the start date, and the end date; retrieving a list of offers by running the query against the rule-based offer database; generating a third user interface with the list of offers, each offer being selectable; and transmitting the third user interface to the display.

In one embodiment, the present disclosure describes a system for generating interfaces for populating a rule-based offer database. The system may comprise at least one memory storing instructions and at least one processor configured to execute the instructions to perform one or more operations. The one or more operations may comprise: generating a first user interface having a first date selector for entry of a start date, a second date selector for entry of an end date, one or more text boxes for entry of one or more room rates, a plurality of graphics, each graphic being associated with a service and being selectable, wherein each graphic is configured to display a text box for entry of a price in response to selection of the graphic, and a first confirmation button; and receiving the start date, the end date, the one or more room rates, and selected services with entered prices upon interaction with the first confirmation button. The one or more operations may further comprise, in response to receiving the start date, the end date, the one or more room rates, and the selected services, generating a second user interface having at least one calendar displaying the start date, the end date, the one or more room rates, at least one text box associated with the at least one calendar for entry of stock, and a second confirmation button. The one or more operations may further comprise receiving the stock upon interaction with the second confirmation button; and storing the start date, the end date, the one or more room rates, the stock, and the selected services with the entered prices in a rule-based offer database upon interaction with the second confirmation button.

The present disclosure also describes computer-implemented methods executed by one or more processors of the present disclosure and non-transitory computer-readable media storing instructions for causing one or more processors to execute such methods.

It is to be understood that the foregoing general description and the following detailed description are examples and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a block diagram of a system for constructing, indexing, and using a rule-based offer database, according to an example embodiment of the present disclosure.

FIG. 2 is a block diagram of a system for generating personalized offers from a rule-based offer database, according to an example embodiment of the present disclosure.

FIG. 3 is an example of a relational structure for a rule-based offer database, according to an example embodiment of the present disclosure.

FIG. 4 is a flowchart of an example method for constructing and indexing a rule-based offer database, according to an example embodiment of the present disclosure.

FIG. 5 is a flowchart of an example method for generating personalized search results using a rule-based offer database, according to an example embodiment of the present disclosure.

FIG. 6 is an example of a graphical user interface (GUI) for displaying a plurality of graphics being associated with services and being selectable, according to an example embodiment of the present disclosure.

FIG. 7 is an example of a graphical user interface (GUI) having a text box for entry of a location or hotel name, date selectors for entry of start and end dates, and a selector for capacity and number of rooms, according to an example embodiment of the present disclosure.

FIG. 8 is an example of a graphical user interface (GUI) for displaying a personalized offer, according to an example embodiment of the present disclosure.

FIG. 9 is an example of a graphical user interface (GUI) for displaying a ranked list of personalized offers, according to an example embodiment of the present disclosure.

FIG. 10 is an example of a graphical user interface (GUI) having date selectors for entry of start and end dates and text boxes for entry of room rates, according to an example embodiment of the present disclosure.

FIG. 11A is an example of a graphical user interface (GUI) for displaying a plurality of graphics being associated with services and being selectable, according to an example embodiment of the present disclosure.

FIG. 11B is an example of the GUI of FIG. 11A where a graphic displays a corresponding text box for entry of a price in response to selection of the graphic.

FIG. 11C is an example of the GUI of FIG. 11A where a graphic displays a corresponding text box for entry of a price and a corresponding menu for entry of a minimum length of stay in response to selection of the graphic.

FIG. 12A is an example of a graphical user interface (GUI) for displaying a calendar displaying a start date, an end date, and one or more room rates, along with a text box for entry of stock, according to an example embodiment of the present disclosure.

FIG. 12B is an example of a graphical user interface (GUI) for displaying a calendar displaying a start date, an end date, and one or more room rates, along with a text box for entry of rates, according to an example embodiment of the present disclosure.

FIG. 13 is an example of a graphical user interface (GUI) for viewing and editing a portion of a rule-based offer database, according to an example embodiment of the present disclosure.

FIG. 14A is an example device for entering input to construct and index a rule-based offer database or for entering input to generate personalized offers therefrom, according to an example embodiment of the present disclosure.

FIG. 14B is an alternative view of the device of FIG. 14A.

FIG. 14C is another example device for entering input to construct and index a rule-based offer database or for entering input to generate personalized offers therefrom, according to an example embodiment of the present disclosure.

FIG. 15 is a block diagram of an example server with which the systems, methods, and apparatuses of the present invention may be implemented.

### DETAILED DESCRIPTION

The disclosed embodiments relate to systems and methods for constructing and indexing a rule-based offer database and for generating personalized offers using the rule-based offer database. Embodiments of the present disclosure may be implemented using a general-purpose computer. Alternatively, a special-purpose computer may be built according to embodiments of the present disclosure using suitable logic elements.

Advantageously, embodiments of the present disclosure may automate and personalize a user's experience using specifically structured graphics in one or more graphical user interface (GUIs). As used herein, the term “user” refers to any person interacting with systems of the present disclosure. Accordingly, a representative of a hotel who inputs information to populate a rule-based offer database, and a consumer who interacts with systems of the present disclosure to search the rule-based offer database and receive personalized offers generated therefrom are both included in the term “user.”

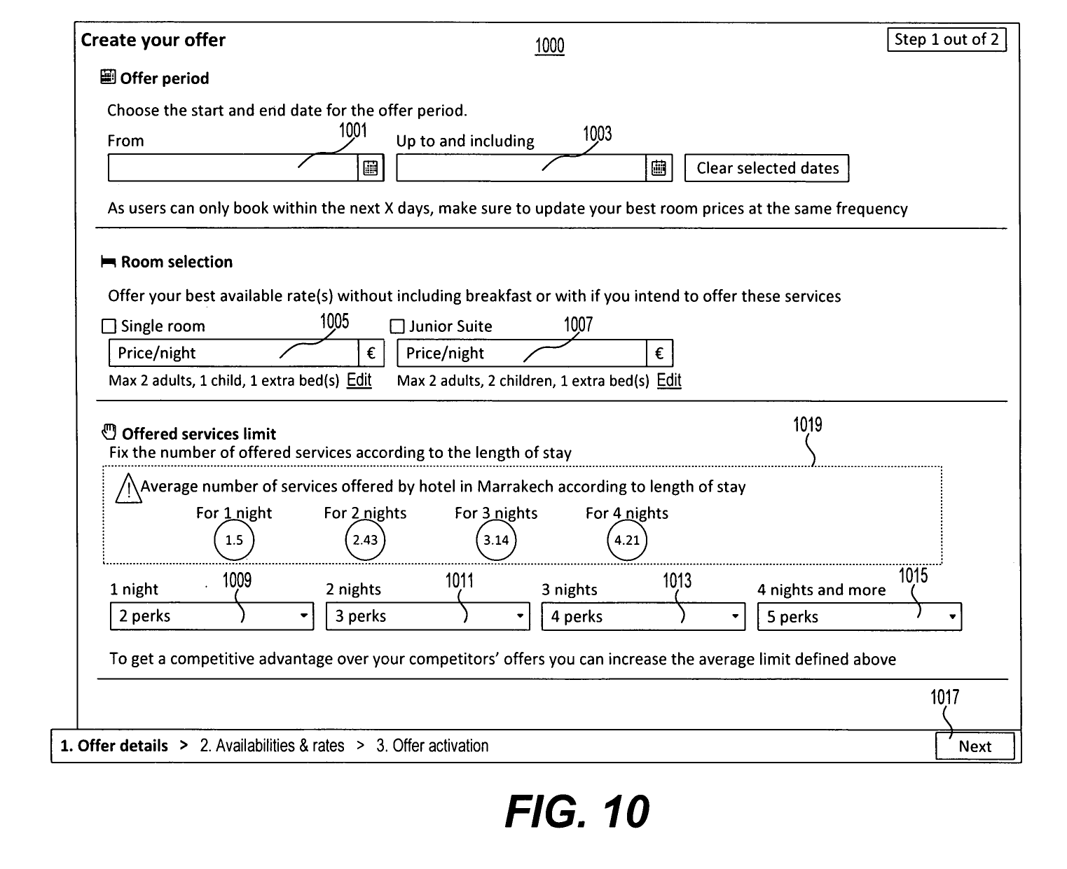

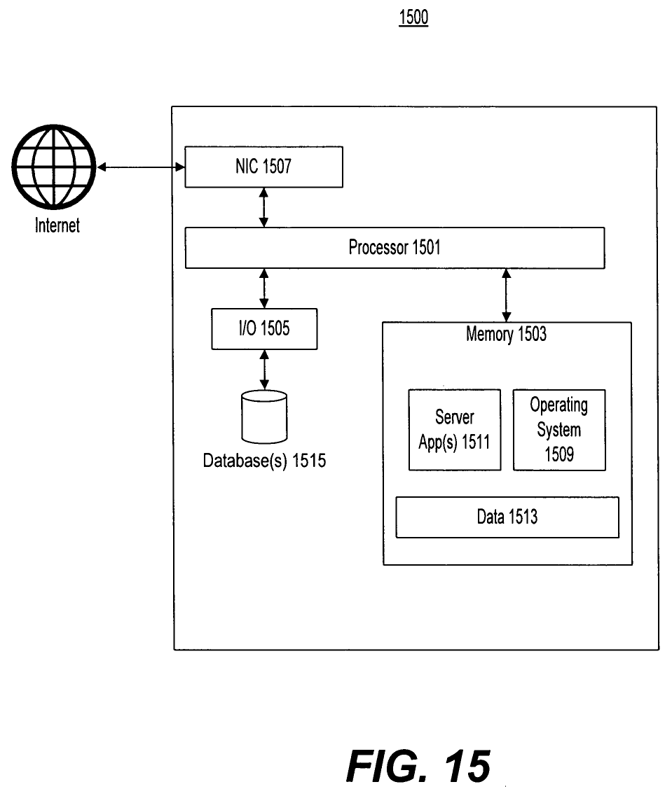

According to an aspect of the present disclosure, a system for constructing and indexing a rule-based offer database may include at least one memory (e.g., a volatile and/or a non-volatile memory) and at least one processor (e.g., a central processing unit (CPU), graphics processing unit (GPU), or other generic processor or a field-programmable gate array (FPGA) or other application-specific integrated circuit (ASIC)). For example, server 1500 of FIG. 15 may construct and index the rule-based offer database. The at least one processor may receive a date rule specifying a start date and an end date. For example, a user may input the date rule using one or more GUI elements, such as date selectors (e.g., selectors 1001 and 1003 of GUI 1000 of FIG. 10). The “date rule” may therefore comprise a data structure that delineates a range of dates in which one or more offers stored in the rule-based offer database are valid.

The at least one processor may also receive a rate rule relating one or more room types to one or more rates. For example, the user may input the rate rule using one or more GUI elements, such as text boxes (e.g., text boxes 1005 and 1007 of GUI 1000 of FIG. 10). The “rate rule” may therefore comprise a data structure that associates rates (e.g., integers representing a price in dollars, euros, or the like) with room types (e.g., indicators of types from a class or array defining possible room types). The room types may comprise previously generated data structures such that the room types included in the rate rule may be selected from a list of the previously generated room types.

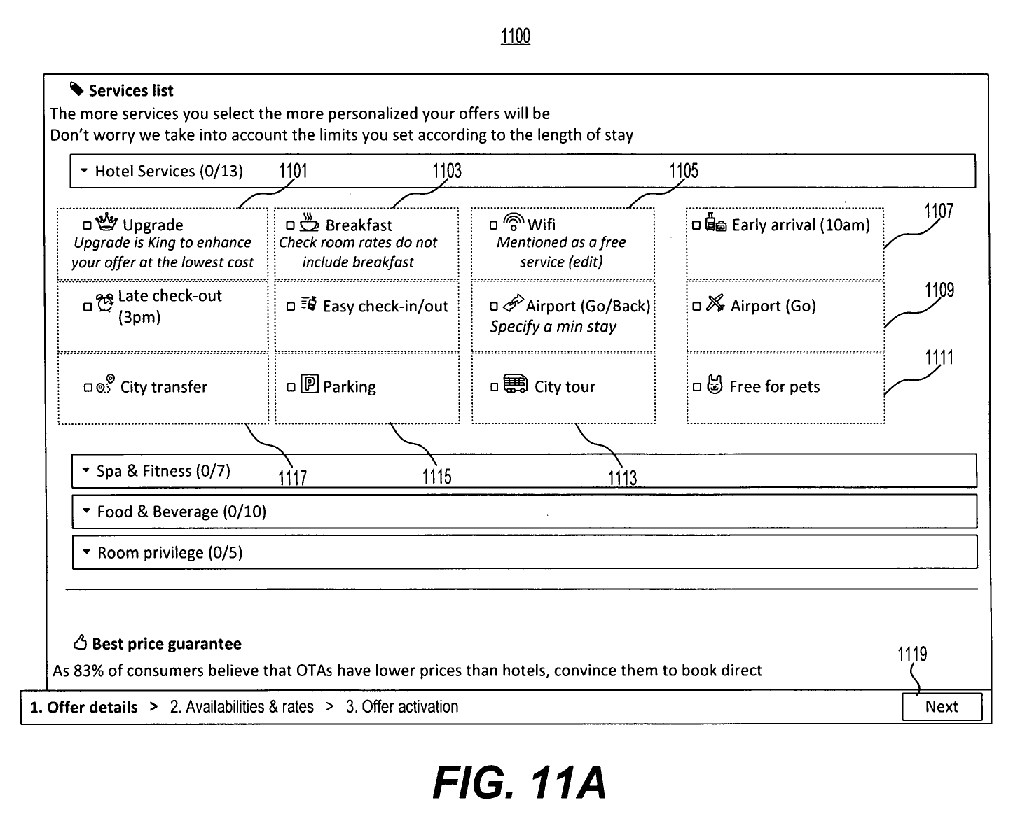

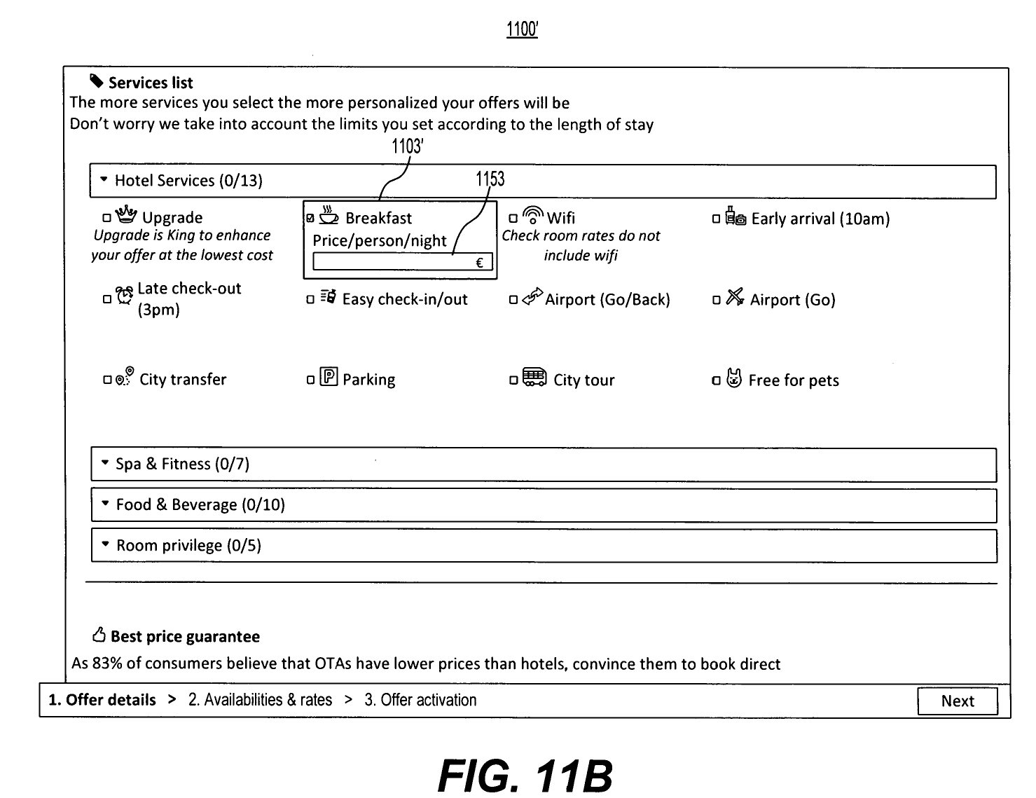

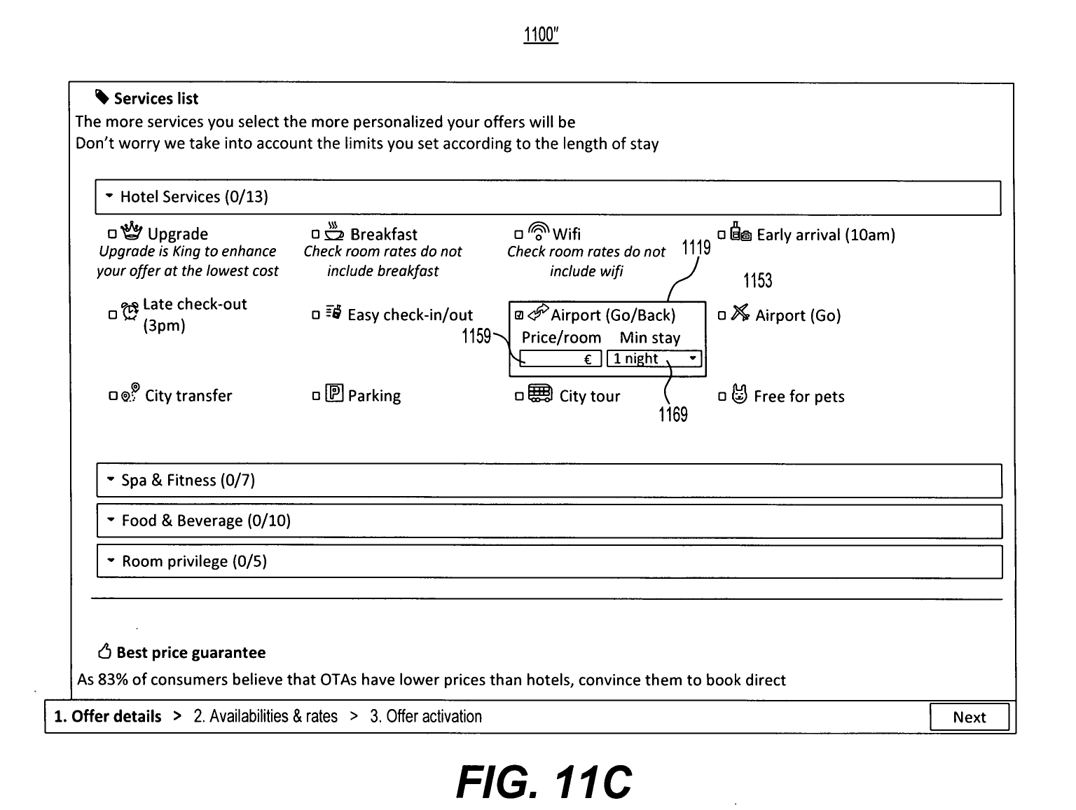

The at least one processor may also receive a services rule relating one or more services to one or more prices. For example, the user may input the services rule using one or more GUI elements, such as selectable graphics (e.g., graphics 1101, 1103, 1105, 1107, 1109, 1111, 1113, 1115, and 1117 of GUI 1100 of FIG. 11A) and text boxes associated therewith (e.g., text box 1153 associated with graphic 1103′ of GUI 1100′ of FIG. 11B or text box 1159 associated with graphic 1119 of GUI 1100″ FIG. 11C). The “services rule” may therefore comprise a data structure that associates services (e.g., indicators of types from a class or array defining possible services) with an indicator of whether the services are offered (e.g., a Boolean or the like) and/or with prices (e.g., integers representing a price in dollars, euros, or the like).

The at least one processor may also receive one or more conditions for coupling to the services rules. For example, the user may input the one or more conditions using one or more GUI elements, such as selectors (e.g., selectors 1009, 1011, 1013, and 1015 of GUI 1000 of FIG. 10 or selector 1169 associated with graphic 1119 of GUI 1100″ FIG. 11C). Some conditions may apply to all services. For example, “conditions” may therefore comprise a data structure that associates lengths of stay (e.g., integers representing a number of days) with amounts of services (e.g., integers representing a number of offered services). Additionally or alternatively, some conditions may apply to specific services. For example, “conditions” may therefore comprise a data structure that associates lengths of stay (e.g., integers representing a number of days) with whether a specific service is available (e.g., a Boolean or the like).

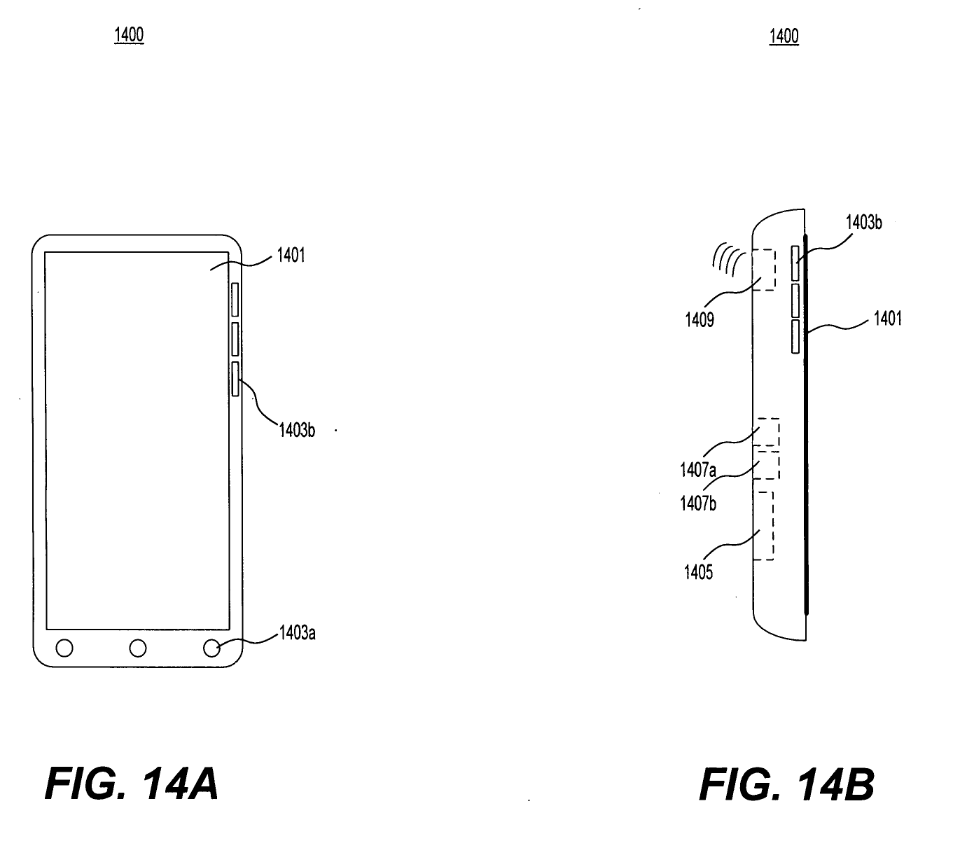

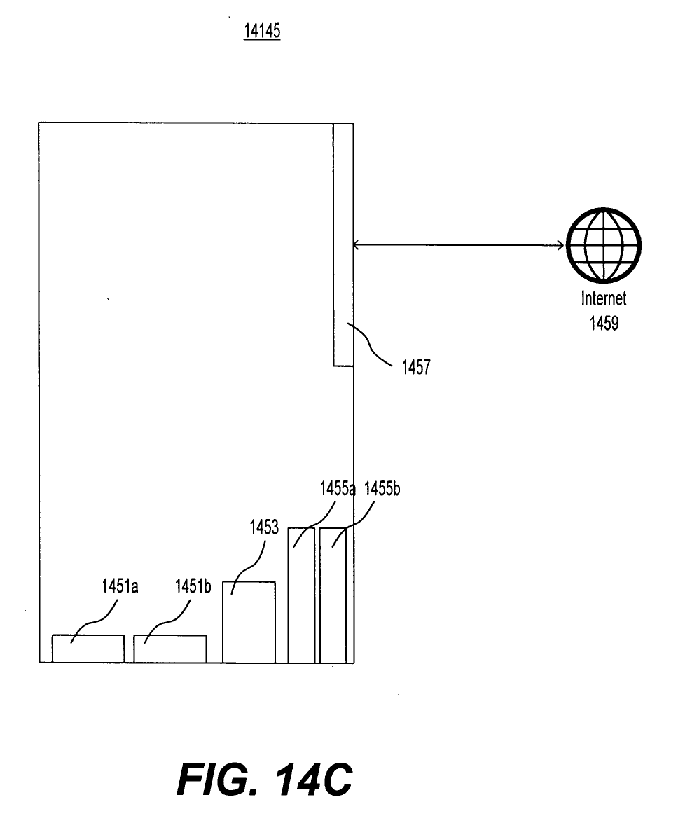

The user may input the rules and conditions using one or more computer networks. For example, the user may use a device (such as device 1400 of FIGS. 14A and 14B or device 1450 of FIG. 14C) to input the rules and conditions (e.g., using one or more GUIs, as explained above), which are then sent over one or more networks (e.g., the Internet, a local area network (LAN), or the like) using one or more standards (e.g., a 4G standard, a Long Term Evolution (LTE) standard, a Wi-Fi standard, a Bluetooth® standard, an Ethernet standard, or the like).

The at least one processor may construct the rule-based offer database. As used herein, the term “construct” refers to any particular method of storing the received date rule, rate rule, services rule, and one or more conditions and/or forming associations between the received date rule, rate rule, services rule, and one or more conditions.

In one embodiment, the at least one processor may construct the rule-based offer database by associating the one or more conditions with the services rule to generate one or more service entities, linking the date rule to the one or more service entities, associating rates of the rate rule to room types of the rate rule to generate one or more room entities, linking the date rule to the one or more room entities, and indexing the date rule for offer generation. In embodiments where the rule-based offer database is relational, each service may be stored in a row with its associated price and associated condition(s) to form an instance of the service entity. Similarly, each rate may be stored in a row with its associated room type to form an instance of the room entity. Accordingly, a relationship may be established between the start date and the end date and the rows comprising instances of the service entities, and a relationship may be established between the start date and the end date and the rows comprising instances of the room entities. Finally, the at least one processor may generate an index based on the start date and the end date such that the related rows may be extracted from the database by searching with one or more dates.

In embodiments where the rule-based offer database is object-oriented, each service may be stored with its associated price and associated condition(s) as an instance of a class representing the service entity. Similarly, each rate may be stored with its associated room type as an instance of a class representing the room entity. Finally, the start date and the end date may be stored as an instance of a class representing a date entity. Accordingly, a relationship may be established between the instance of the date entity class and the instances of the classes representing the service entities, and a relationship may be established between the instance of the date entity class and the instances of the classes representing the room entities, as well as between the instances of the classes representing the service entities and the instances of the classes representing the room entities. Finally, the at least one processor may generate an index based on the instance of the date entity class such that the related instances may be extracted from the database by searching with one or more dates.

In embodiments where the rule-based offer database is graphical, each service may be stored as a node representing the service entity with its associated price and associated condition(s) as attributes of the node. Similarly, each rate may be stored as a node representing the room entity with its associated room type as attributes of the node. Finally, the start date and the end date may be stored as a node. Accordingly, edges may be established between the node having the start date and the end date and the nodes representing the service entities and between the node having the start date and the end date and the nodes representing the room entities, as well as between the nodes representing the service entities and the nodes representing the room entities. Finally, the at least one processor may generate an index based on the start date and the end date such that the service nodes and the room nodes may be extracted from the database by searching with one or more dates.

In embodiments where the rule-based offer database is graphical, each service may be stored as a node representing the service entity with its associated price and associated condition(s) as attributes of the node. Similarly, each rate may be stored as a node representing the room entity with its associated room type as attributes of the node. Similarly each room type may be stored as a node representing the room entity with its associated price and associated condition(s) (e.g stock and rates) as attributes of the node. Finally, the start date and the end date may be stored as a node. Accordingly, edges may be established between the node having the start date and the end date and the nodes representing the service entities and between the node having the start date and the end date and the nodes representing the room entities, as well as between the nodes representing the service entities and the nodes representing the room entities. Finally, the at least one processor may generate an index based on the start date and the end date such that the service nodes and the room nodes may be extracted from the database by searching with one or more dates.

One of ordinary skill will recognize that other database structures may be used in lieu of the structures described above. For example, hierarchical structures may be used based on the same principles described above.

In any of the embodiments described above, an automatic offer generated using the rule-based offer database may include stock that is modified by a later change to the rule-based offer database. For example, the at least one processor may receive input reducing the stock to zero (if stock goes to zero, the corresponding room type cannot be assigned) and may detect that at least one automated offer includes one or more rooms from the reduced stock. Accordingly, in response, the at least one processor may automatically adjust the at least one automatic offers (or generate replacement automatic offers) including rooms from stock that was not reduced (such that another room type available will be included in the offers). If there are no room types with enough stock available, an adjusted or replacement offer cannot be generated (e.g., the system may output an error).

The systems of the present disclosure may also generate interfaces for populating a rule-based offer database. According to an aspect of the present disclosure, a system for generating the interfaces may include at least one memory (e.g., a volatile and/or a non-volatile memory) and at least one processor (e.g., a CPU, GPU, or other generic processor or a FPGA or other ASIC). For example, server 1500 of FIG. 15 may generate the interfaces to facilitate constructing and indexing the rule-based offer database, as described above.

For example, the at least one processor may generate a first user interface having a first date selector for entry of a start date, a second date selector for entry of an end date, one or more text boxes for entry of one or more room rates, a plurality of graphics, each graphic being associated with a service and being selectable, and a first confirmation button. An example of the first user interface is depicted in FIGS. 10 and 11A, described below. Although depicted separately, GUI 1100 of FIG. 11A may represent a lower portion of GUI 1000 of FIG. 10 such that GUI 1100 is visible when a user of GUI 1000 scrolls down.

GUI 1000 includes the first date selector 1001 and the second date selector 1003. GUI 1000 further includes text boxes 1005 and 1007 for entry of room rates. As further depicted in FIG. 11A, GUI 1100 includes a plurality of selectable graphics, e.g., graphics 1101, 1103, 1105, 1107, 1109, 1111, 1113, 1115, and 1117. GUI 1000 and GUI 1100 both include the first confirmation button 1017 and 1119, respectively. Button 1017 and 1119 may comprise the same button. For example, button 1017 may remain stationary while the user of GUI 1000 scrolls down, revealing GUI 1100.

Furthermore, each graphic of the first user interface may be configured to display a text box for entry of a price in response to selection of the graphic. For example, as depicted in FIG. 11B, described below, graphic 1103′ has been selected, e.g., via a mouse click, a tap on a touchscreen displaying GUI 1100′, or the like. In response to the interaction, GUI 1100′ now includes text box 1153 for entering a price.

Some graphics, such as graphic 1105, may be associated with a service that was previously indicated as free by the hotel. For example, in FIG. 11A, Wifi has been selected as a service provided by free by the hotel. Accordingly, selection of graphic 1105 may not result in an element for entry of a price and/or an element for entry of a condition (such as a minimum stay). Moreover, graphic 1105 may include a link (e.g., the “edit” text) to another interface for modification of the associated service from a free service to one associated with a price.

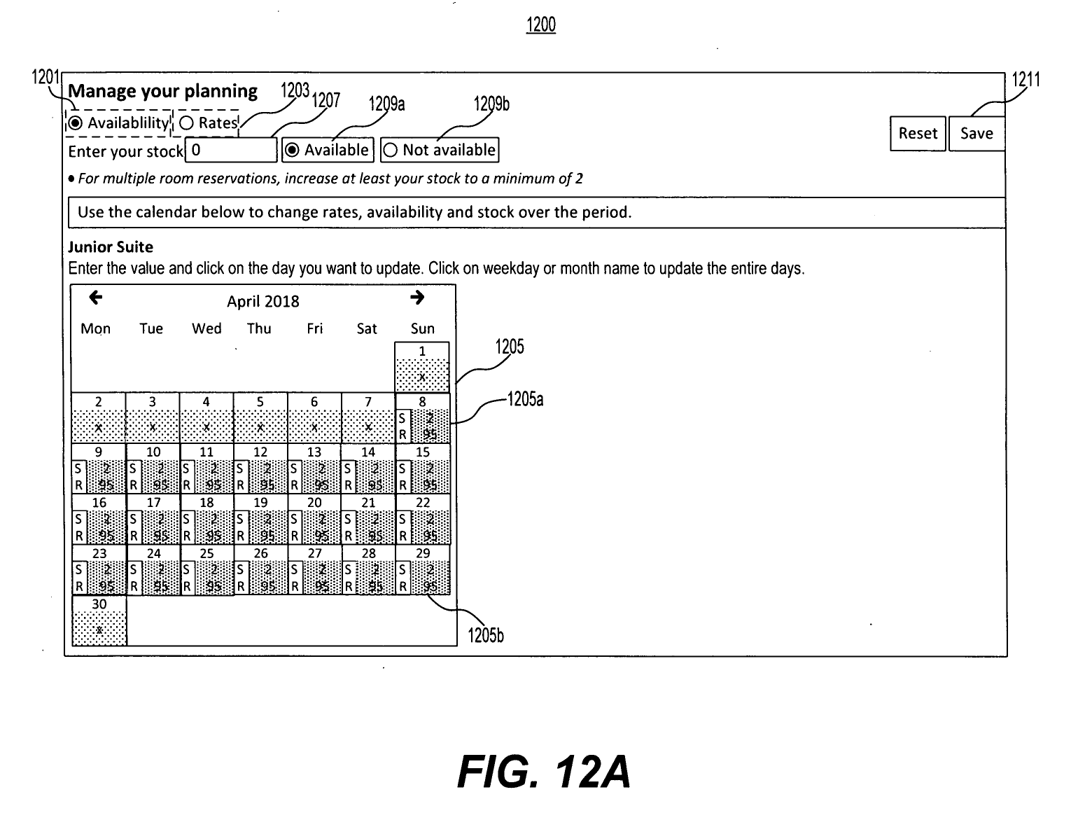

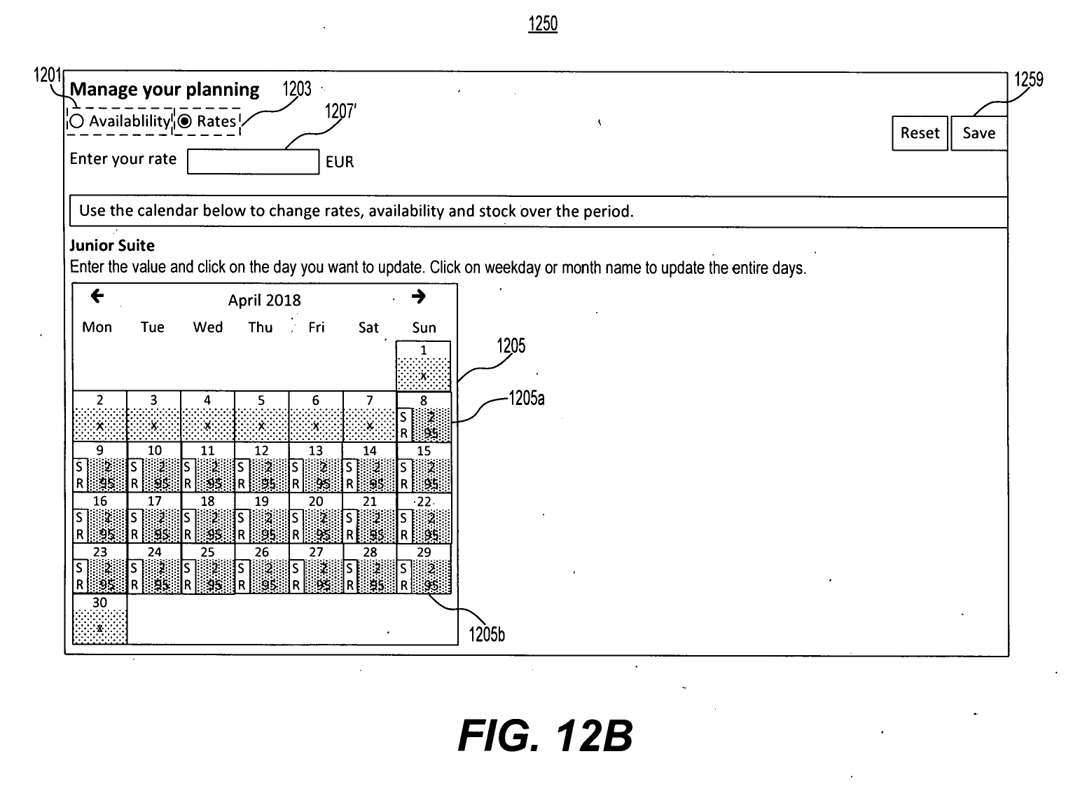

The at least one processor may receive the start date, the end date, the one or more room rates and selected services with entered prices upon interaction with the first confirmation button (e.g., button 1017 and/or button 1119). In response to receiving the start date, the end date, the one or more room rates and the selected services, the at least one processor may generate a second user interface having at least one calendar displaying the start date, the end date, the one or more room rates, at least one text box associated with the at least one calendar for entry of stock, and a second confirmation button. An example of the second user interface is depicted in FIGS. 12A and 12B, described below. Although depicted separately, GUI 1250 of FIG. 12B may represent a modification to GUI 1200 of FIG. 12A when radio button 1203 is selected rather than radio button 1201.

GUI 1200 includes the calendar 1205 displaying the start date 1205a and the end date 1205b. The calendar also displays room rates (displayed next to “R” on each date, such as start date 1205a and the end date 1205b) and includes a text box 1207 for entry of stock. In alternative GUI 1250, text box 1207′ may be used for entry of room rates rather than stock. GUI 1200 and GUI 1250 both include the second confirmation button 1209 and 1259, respectively.

The at least one processor may receive the stock upon interaction with the second confirmation button (e.g., button 1209 and/or button 1259). The at least one processor may store the start date, the end date, the one or more room rates, the stock, and the selected services with the entered prices in a rule-based offer database upon interaction with the second confirmation button. For example, the at least one processor may construct the rule-based offer database as described above. In some embodiments, the at least one processor may construct the rule-based offer database in response to receiving the stock.

Once constructed and indexed, the rule-based offer database described above may be used to automatically provide personalized offers to a searcher. According to an aspect of the present disclosure, a system for generating personalized search results using a rule-based offer database may include at least one memory (e.g., a volatile and/or a non-volatile memory) and at least one processor (e.g., a CPU, GPU, or other generic processor or a FPGA or other ASIC). For example, server 1500 of FIG. 15 may search the rule-based offer database and apply the rules to generate the personalized results.

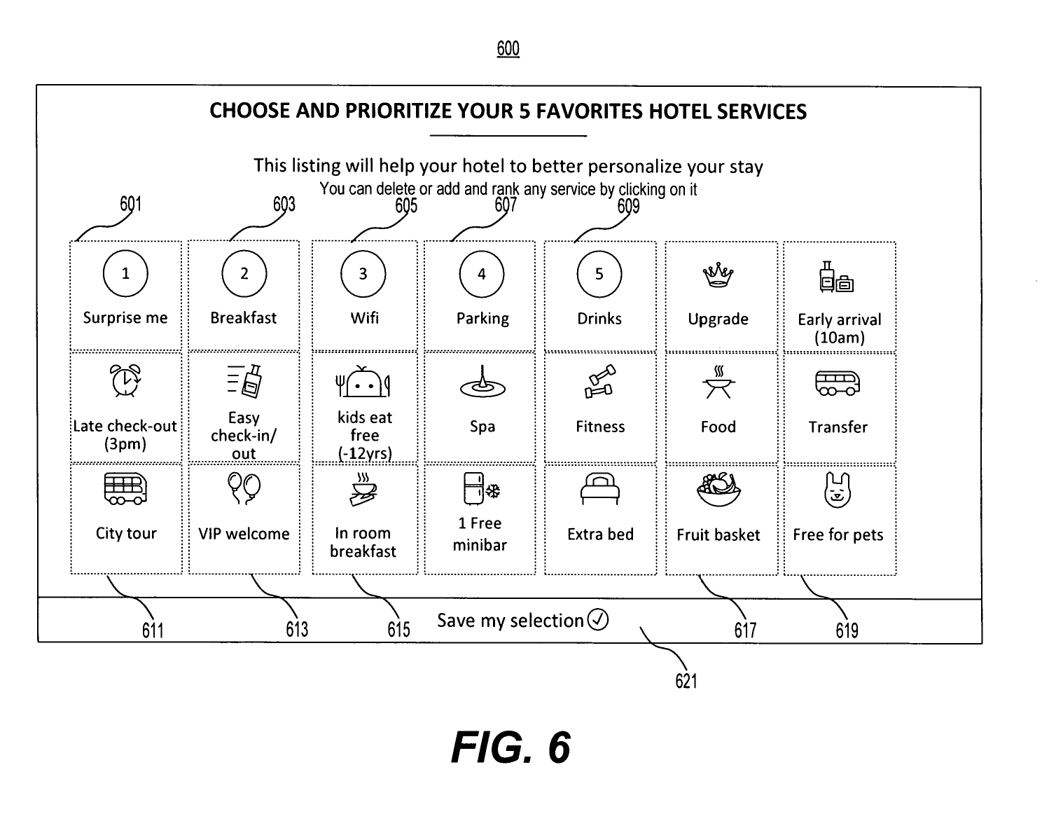

The at least one processor may receive one or more favorite services from a user. For example, a user may input the favorite rule using one or more GUI elements, such as selectable graphics (e.g., graphics 601, 603, 605, 607, 609, 611, 613, 615, 617, and 619 of GUI 600 of FIG. 6). The “favorite services” may therefore comprise a data structure that delineates one or more services in a predefined set of services to use.

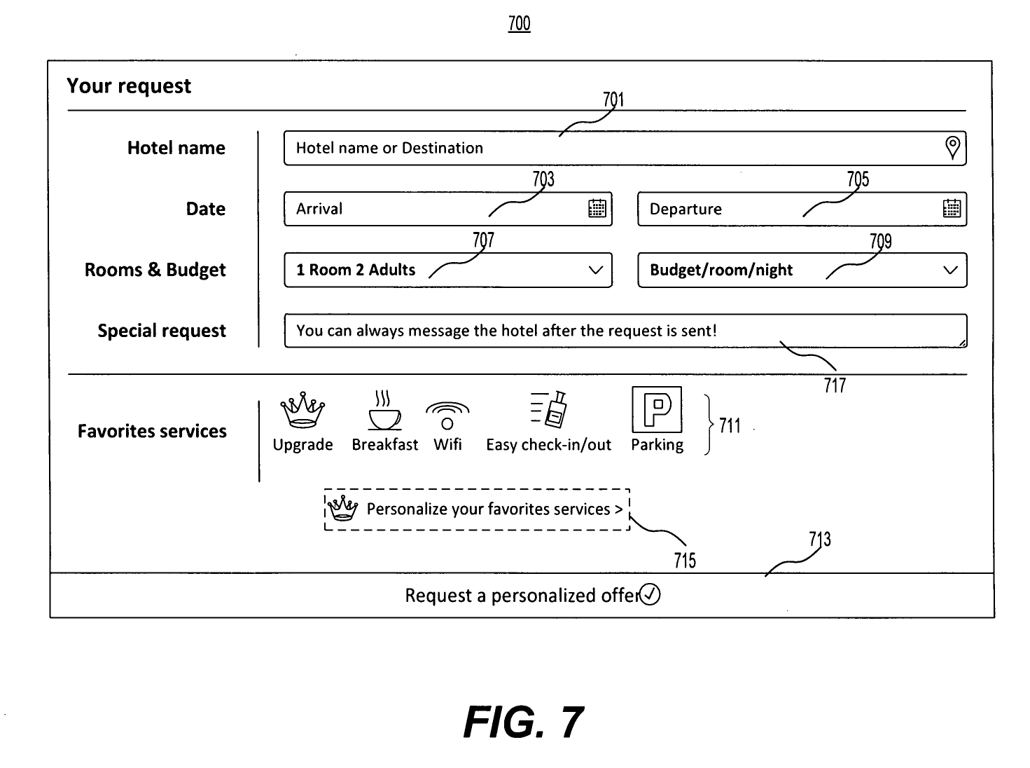

The at least one processor may further receive a start date and an end date from the user. For example, the user may input the start date and the end date using one or more GUI elements, such as date selectors (e.g., date selector 703 and date selector 705 of GUI 700 of FIG. 7).

The at least one processor may also receive a capacity and a number of rooms from the user. For example, the user may input the number of rooms and the capacity using one or more GUI elements, such as selectors and/or text boxes (e.g., selector 707 of GUI 700 of FIG. 7).

The at least one processor may select stock using the rule-based offer database. For example, the at least one processor may select stock by mapping the start date and the end date onto one or more date rules including both the start date and the end date and mapping the capacity and the number of rooms onto one or more rooms. In some embodiments, the at least one processor may generate a query including the start date and the end date and execute the query against the rule-based offer database (or an index thereof). In addition, the at least one processor may filter the results from the query using the capacity and the number of rooms.

The at least one processor may further select services using the rule-based offer database. For example, the at least one processor may apply one or more rules stored in the database to select a number of services and then select services based on the favorite services of the user. The selection may further be limited by conditions stored in the database. Accordingly, the at least one processor may select services by mapping the one or more favorite services onto one or more services of the rule-based offer database, selecting a subset of the one or more services for which one or more conditions are met, and ranking the subset based on a priority input by the user. For example, if a first service is ranked as higher than a second service by the user, the first service may be prioritized within the subset over the second service.

In one example, the at least one processor may sequentially process a list of services input by the user, e.g., in descending order of priority, as indicated by the user. Each service on the list may be checked against a list of services in the rule-based offer database offered by a particular hotel. If a match is found, the service on the list may be checked against any associated conditions in the rule-based on offer database (e.g., a minimum stay) and then selected if the condition(s) are met.

If the entire list of services has been processed and a number of selected services does not match a number of services required by a services condition (e.g., requiring 4 services if a length of stay is for 3 nights), the at least one processor may randomly select services offered by the hotel and/or may sequentially add services from a priority list input by the hotel (or from a default priority order determined by the system).

In some embodiments, the user may input one or more categories (e.g., “spa,” “food,” “beverage,” or the like) in addition to or in lieu of specific services. In such embodiments, the at least one processor may determine whether the hotel offers services in a matching category and then select a service within that category randomly or based on a priority list input by the hotel or generated by the at least one processor. For example, the at least one processor may select a free spa massage if available in lieu of selecting a spa discount. Alternatively, the system may assign services based on a ranking of value of the services. For example, the system may determine values of the services by averaging prices of the services within a city and/or vicinity of the hotel and assign services in descending order of determined value. The system may determine value of services by checking which services has the highest minimum stay condition and assign such services based on descending order of determined value. Alternatively, the system may determine cash values of the services by multiplying the price (or average price) of the each service by the number of nights, number of rooms, and/or number of persons included in the user's request.

The at least one processor may generate one or more offers that match the one or more rooms with the ranked services. In some embodiments, the one or more rooms may be matched with same services unless an upgrade is added, as explained below. For example, the number of services from the ranked subset of services for which the one or more rules and/or the one or more conditions are met may be combined with the stock based on an identity of a hotel with which the services and the stock are associated. Accordingly, the at least one processor may ensure that offers only include services provided by the hotel in which the stock is available. For example, if the stock in the database indicates that an upgrade is available, the at least one processor may include the upgraded room in the offer as opposed to a base room if an upgrade is selected by the user and indicated as available by the hotel. As used herein, an “upgraded room” comprises a room of a higher category (e.g., having a higher price, a larger square footage, additional beds, and/or additional amenities such as a kitchenette, a minibar, or the like) than the base room.

The at least one processor may calculate disparities between prices of the one or more rooms and the ranked services and rates retrieved from the rule-based offer database. For example, the at least one processor may select the rates from the rule-based offer database as the prices and then determine the disparity as prices of the services in the database. In embodiments where a room upgrade is offered, the disparity may further include a difference between a price of the upgraded room in the database and a price of the base room in the database.

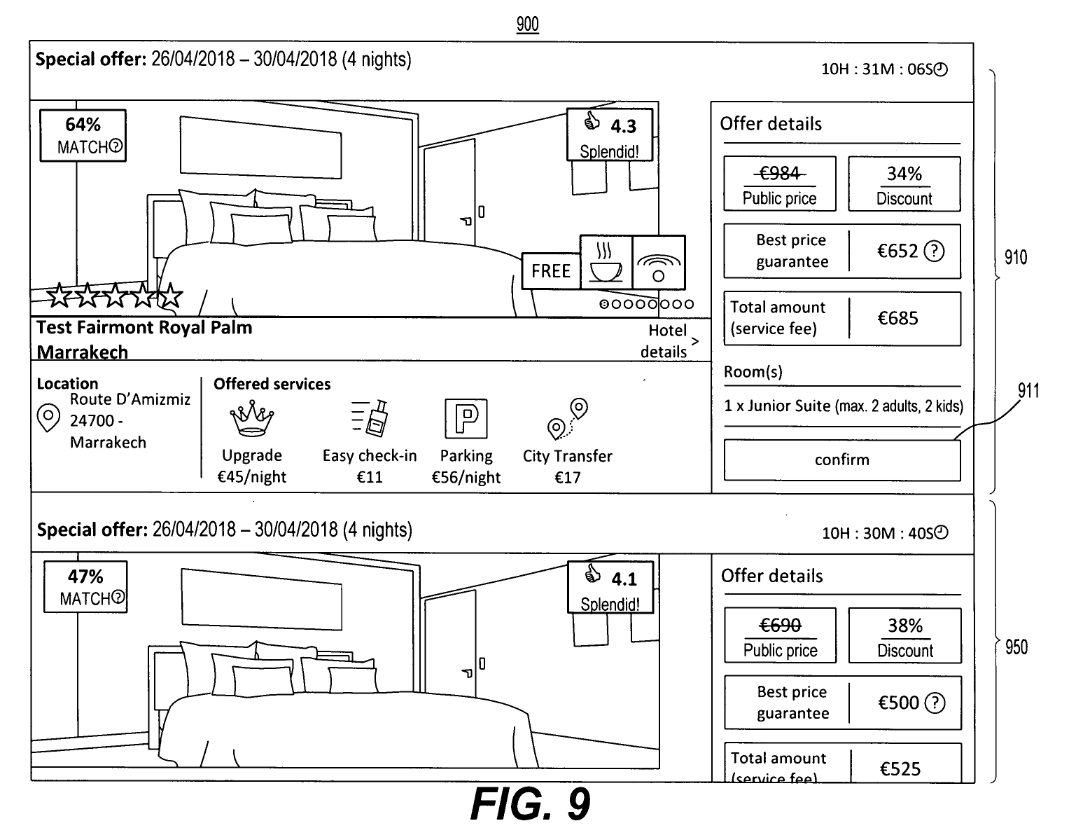

The at least one processor may generate a user interface with a ranked list of the generated offers that allows the user to select an offer from the generated offers. An example of such a user interface is depicted in FIG. 9, described below. The ranking may be based on matching percentages between the user's input and the generated offers. In some embodiments, the matching percentage may be based, at least in part, on a relation between a number of the services included in the offer and a number of days between the start date and the end date (e.g., as compared to the average number of offered services within a geographic region including the hotel), based on an overlap between the services included in the offer and the one or more favorite services, and/or based on a degree of overlap between a budget input by the user and the price of the automatic offer. The user may then select an offer from the ranked list and finalize payment of the offer and reservation thereof.

The systems of the present disclosure may also generate interfaces for searching a rule-based offer database. According to an aspect of the present disclosure, a system for generating the interfaces may include at least one memory (e.g., a volatile and/or a non-volatile memory) and at least one processor (e.g., a CPU, GPU, or other generic processor or a FPGA or other ASIC). For example, server 1500 of FIG. 15 may generate the interfaces to facilitate searching and receiving results from the rule-based offer database, as described above.

For example, the at least one processor may generate a first user interface displaying a plurality of graphics. An example of the first user interface is depicted in FIG. 6, described below. GUI 600 includes a plurality of graphics, e.g., graphics 601, 603, 605, 607, 609, 611, 613, 615, 617, and 619. Each graphic is associated with a service and selectable. In the example of FIG. 6, graphics 601, 603, 605, 607, and 609 have been selected, e.g., via a mouse click, a tap on a touchscreen displaying GUI 600, or the like. GUI 600 also includes a confirmation button 621. Accordingly, the at least one processor may transmit the first user interface to a display associated with a user and receive, based on interaction with the first user interface (e.g., the mouse click(s), tap(s), or the like), a selection of one or more services from the user. Accordingly, the at least one processor may receive the selected services based on which graphics have been selected.

In response to the selection of services, the at least one processor may generate a second user interface. The second user interface may have a text box for entry of a location or a hotel name, a first date selector for entry of a start date, a second date selector for entry of an end date, a first selector for capacity, and a second selector for a number of rooms. An example of the second user interface is depicted in FIG. 7, described below. GUI 700 includes a text box 701 for entry of a location or a hotel name. GUI 700 also includes a date selector 703 for entry of a start date and a date selector 705 for entry of an end date. GUI 700 further includes a selector 707 for a number of rooms and capacity. In addition, in some embodiments, GUI 700 may further include a selector 709 (or a text box, not shown) for entry of a budget.

Accordingly, selector 707 comprises the first selector and the second selector. GUI 700 may also include graphics 711 indicating the selected services from the first user interface. To facilitate modification of the selected services, GUI 700 may include a link 715 back to the first user interface or other user interface to facilitate selection of, at least in part, new services. In the example of FIG. 7, GUI 700 also includes a confirmation button 713. Accordingly, the at least one processor may transmit the second user interface to the display and receive, based on interaction with the second user interface (e.g., a mouse click, a tap, or the like), the location, the start date, the end date, the capacity, and the number of rooms from the user.

In response to receiving the location, the start date, and the end date, the capacity, and the number of rooms, the at least one processor may generate a query based on the selection, the location or the hotel name, the start date, and the end date. For example, the query may comprise a database language query (e.g., a Structure Query Language (SQL) query) to pull offers from the rule-based offer database. For example, the start date and the end date may be queried against an index of dates, and the location or the hotel name may be queried against an index of addresses or hotel names, respectively. The rules of the database may be applied to select services. Accordingly, the at least one processor may retrieve a list of offers by running the query against the rule-based offer database.

Although explained above with graphical users elements, GUIs 600 and 700 may instead be configured for use of voice searching. In such embodiments, the first user interface and/or the second user interface may be different than depicted in FIGS. 6 and 7, respectively, to facilitate the use of voice search.

The at least one processor may generate a third user interface. The third user interface may have the list of offers, each offer being selectable. An example of the third user interface is depicted in FIG. 9, described below. GUI 900 includes a list of offers, e.g., offer 910 and offer 950. Each offer is selectable, e.g., offer 910 is selectable using confirmation button 911. Accordingly, the at least one processor may transmit the third user interface to the display and receive, based on interaction with the third user interface (e.g., a mouse click, a tap, or the like), a selection of an offer on the list from the user. The at least one processor may then facilitate finalization of the offer with the user (e.g., by facilitating payment from the user and transmitting the reservation to a system associated with a hotel of the selected offer for confirmation).

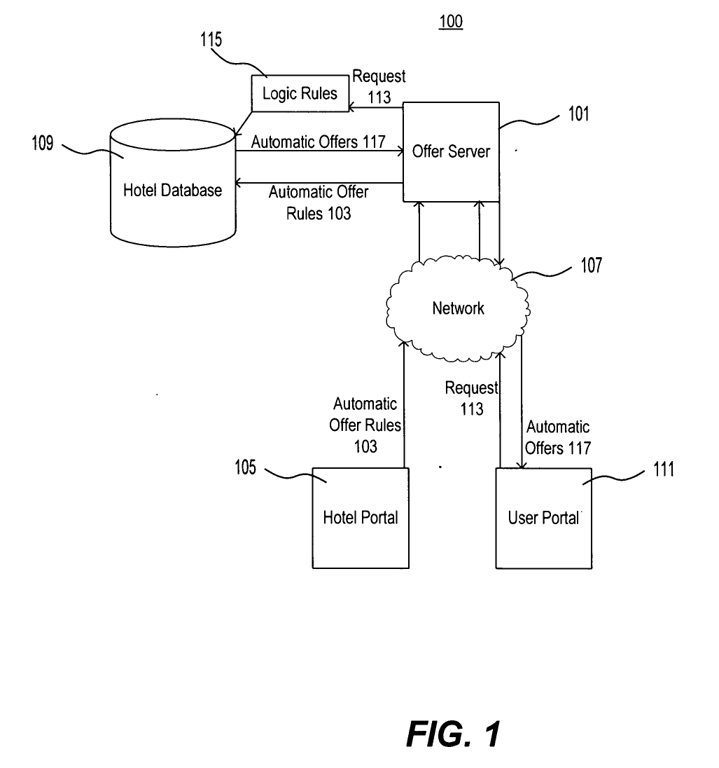

Turning now to FIG. 1, there is shown an example system 100 for constructing, indexing, and using a rule-based offer database. As depicted in FIG. 1, system 100 may include an offer server 101. Offer server 101 may comprise, for example, server 1500 of FIG. 15, described below.

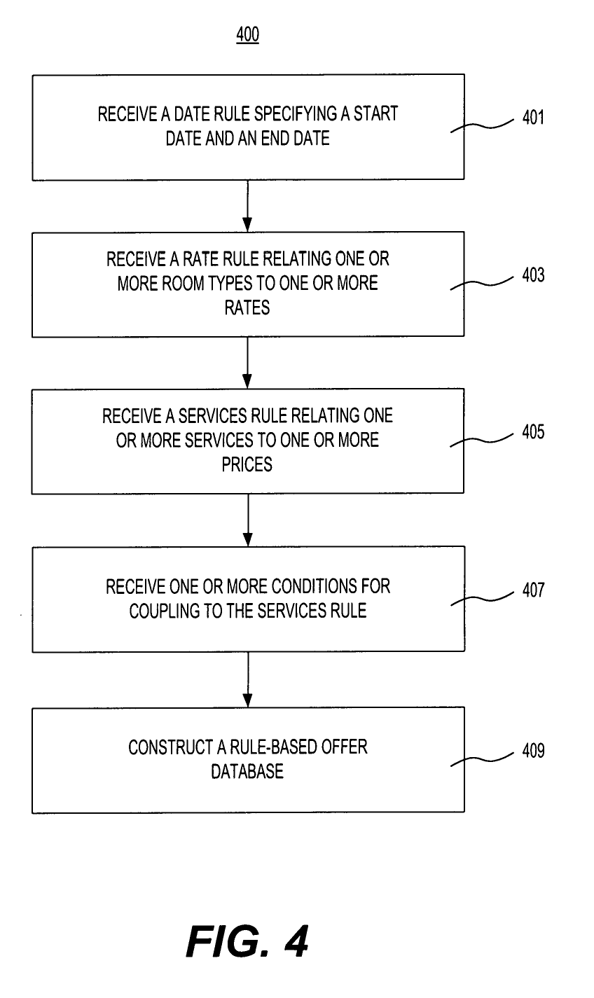

Offer server 101 may receive automatic offer rules 103 using a hotel portal 105. For example, as described below, offer server 101 may execute method 400 of FIG. 4 to receive automatic offer rules 103 and populate hotel database 109 with the same. As further depicted in FIG. 1, offer server 101 may receive automatic offer rules 103 through one or more computer networks, e.g., network 107.

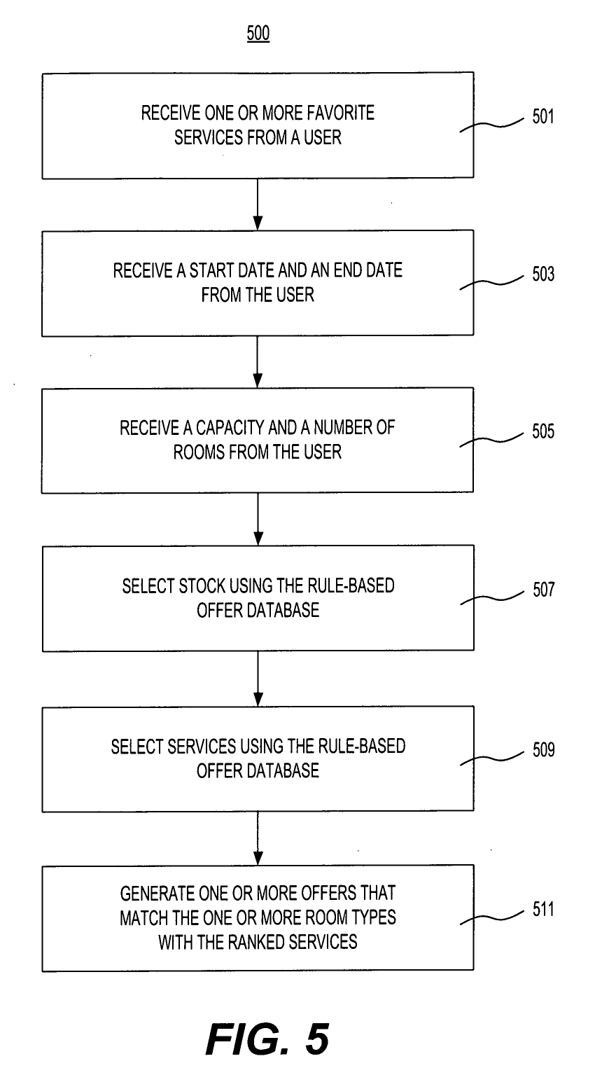

Offer server 101 may also receive requests, e.g., request 113, using a user portal 111. For example, as described below, offer server 101 may execute method 500 of FIG. 5 to use one or more rules (e.g., logic rules 115) to query hotel database 109 using request 113 and filter the results therefrom to obtain automatic offers 117. As further depicted in FIG. 1, offer server 101 may receive request 113 and return automatic offers 117 through one or more computer networks, e.g., network 107.

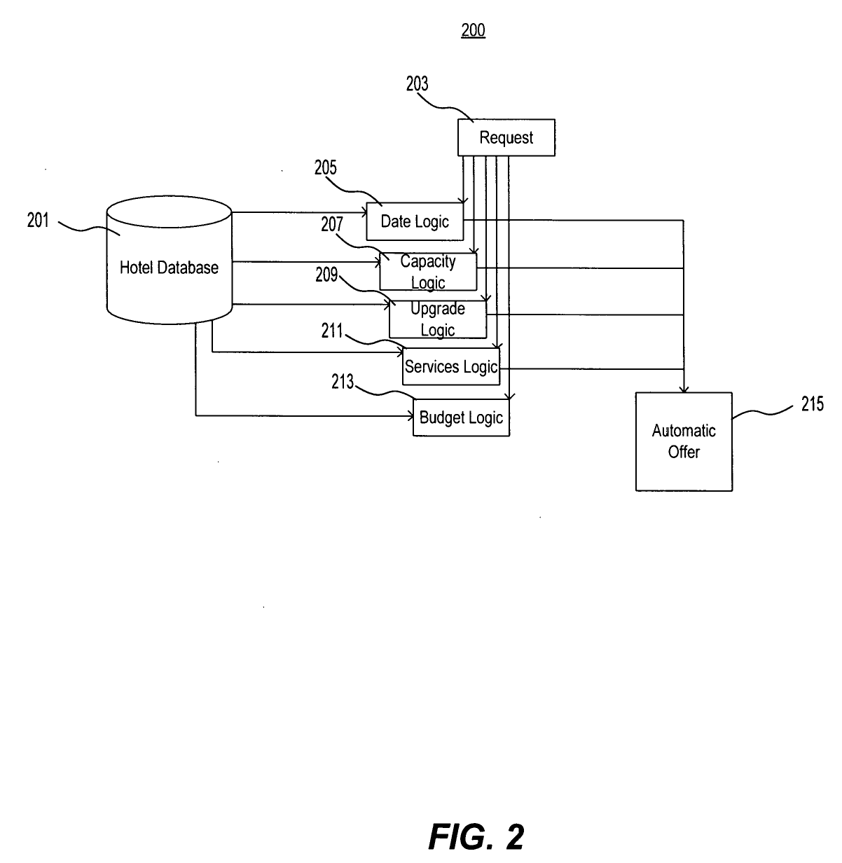

FIG. 2 depicts an example system 200 for generating personalized offers from a rule-based offer database. For example, system 200 may represent a detailed depiction of logic rules 115 of FIG. 1.

As depicted in FIG. 2, system 200 may receive a request 203 (which may, for example, comprise request 113 of FIG. 1). Request 203 may include, for example, a start date, an end date, a capacity, and a number of rooms. In some embodiments, request 203 may also include a location or a hotel name and/or a budget. As depicted in FIG. 2, system 200 may generate an automatic offer 215 by applying date logic 205 to request 203 and to entries in hotel database 201, capacity logic 207 to request 203 and to entries in hotel database 201, upgrade logic 209 to request 203 and to entries in hotel database 201, and services logic 211 to request 203 and to entries in hotel database 201. In some embodiments, as further depicted in FIG. 2, system 200 may apply budget logic 213 to request 203 and to entries in hotel database 201 to generate automatic offer 215.

For example, date logic 205 may ensure that any automatic offer 215 is valid from the start date to the end date included in request 203. Moreover, capacity and room logic 207 may ensure that any automatic offer 215 includes enough beds to accommodate the capacity included in request 203 and includes enough rooms to include at least the number of rooms included in request 203. Upgrade logic 209 may determine whether a room of a higher category may be selected for automatic offer 215. For example, upgrade logic 209 may make the determination based on the length of stay (that is, the days between the start date and the end date, counting inclusively of the end date but exclusively of the start date), based on the capacity, and/or based on whether request 203 includes an upgrade and hotel database 201 indicates that an upgrade is available. Services logic 211 may select a number of services to add to automatic offer 215. For example, services logic 211 may select the number based on the length of stay and may select the particular services based on favorite services of a user submitting request 203. The favorite services may be ranked such that services logic 211 further accounts for the ranking. In embodiments including budget logic 213, budget logic 213 may ensure that any automatic offer 215 has a price that is below a threshold and/or within a range included in request 203.

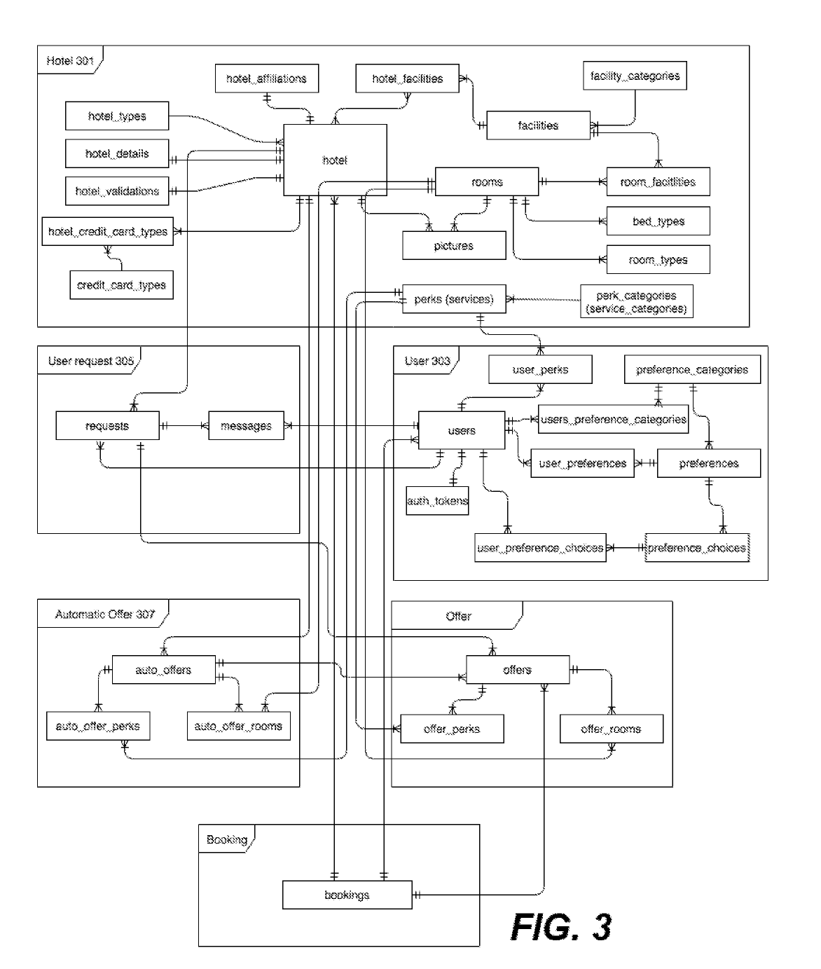

FIG. 3 is a schematic representation of an example relational structure 300 for a rule-based offer database. As depicted in structure 300, each hotel 301 may include a bed_types entity and a perk_categories entity. The bed_types entity may comprise an integer indicating the number of bed types (e.g., king, queen, twin, or the like) at hotel 301. The perk_categories entity may comprise categories of perks (e.g., hotel services, spa and fitness, food and beverage, room privilege, or the like) provided by hotel 301. A perks entity may define a service (e.g., breakfast, airport shuttle, fruit bowl, early check in, late check out, or the like) offered by the hotel and may have a many-to-one relationship with perk_categories.

Structure 300 may further comprise a facilities_category entity having a one-to-many relationship with facilities entities, which have a one-to-many relationship with hotel_facilities entities and room_facilities entities. The facilities_category entity may comprise categories of facilities (e.g., business center, pool, guest room, or the like) provided by hotel 301. Accordingly, each facilities entity may include an indicator of the category of the facility and an indicator whether there is a cost associated therewith. Moreover, each hotel_facilities entity and room_facilities entity may include a cost associated therewith. The hotel_facilities may have a many-to-many relationship with the hotels entities.

As further depicted in FIG. 3, structure 300 may comprise rooms entities having a one-to-many relationship with pictures entities and the room_facilities entities. The rooms entity may comprise an identifier of the bed type included in the room type represented by the entity, one or more integers indicating the occupancy of the room type (e.g., an integer representing total capacity, an integer representing adult capacity, an integer representing child capacity, or the like), and a price associated with the room type. The pictures entities may include (or link to) pictures of room types represented by linked rooms entities. The pictures entities may also have a many-to-one relationship with the hotel entity. The room_types entity may comprise categories of room types (e.g., standard queen, standard king, junior suite, executive suite, or the like) provided by hotel 301. Similarly, the bed_types entity may comprise categories of bed types (e.g., queen, king, standard, or the like) provided by hotel 301. The room_types entity may have a many-to-one relationship with the rooms entities, as may the bed_types entity.

Each hotel_affiliations entity may comprise a name and an email of a hotel and/or other information input during registration of the hotel with a system (e.g., system 100) providing database 300, such that each hotel (e.g., hotel 301) has a hotel_affiliations entity linked to a corresponding hotel entity.

As further depicted in FIG. 3, structure 300 may comprise hotels entities having a many-to-one relationship with the rooms entities, a one-to-one relationship with hotel_validations entities, hotel_details entities, and hotel_types entities. Each hotels entity may comprise a name, an email (and/or other contact information), an address (and/or other location information) of the hotel represented by the hotels entity (e.g., hotel 301). Each hotel_validations entity may comprise one or more Booleans or other indicators of whether details of the hotel represented by a linked hotels entity have been verified. Each hotel_details entity may comprise indicators of whether certain services (such as Internet, breakfast, pet accommodation, parking, or the like) are provided by the hotel represented by a linked hotels entity (e.g., hotel 301) and prices of such services, if applicable. A hotel_types entity may comprise an integer indicating a category (e.g., hostel, guesthouse, hotel, or the like) of the hotel represented by a linked hotels entity (e.g., hotel 301).

Moreover, the hotels entities may have a one-to-many relationship with hotel_credit_card_types entities and user_hotel entities. Each user_hotel entity may comprise an identification of a user permitted to modify one or more entities of the hotel represented by a linked hotels entity (e.g., hotel 301) in structure 300. Accordingly, each user_hotel entity may represent a user such as a hotel manager, a front desk manager, or other employee permitted to modify the one or more entities. Each hotel_credit_card_types entity may comprise an identifier of a type of credit card (e.g., Visa®, Mastercard®, American Express®, or the like) accepted by the hotel represented by a linked hotels entity (e.g., hotel 301). The hotel_credit_card_types entities may also have a many-to-one relationship to a credit_card types entity, which may comprise an integer indicating the number of categories of credit cards.

As further depicted in structure 300, each user 303 may include a users entity having a one-to-many relationship with user_preference_categories entities and a one-to-many relationship with user_preferences entities. Each users entity may comprise one or more identifiers (such as a username, a legal name, an address or other location information, an email or other contact information, or the like) of the user represented by the entity (such as user 303). Each user_preference_categories entity may comprise categories of preferences (e.g., breakfast, lunch and dinner, wines and beverages, spirits, or the like) for which a user may submit preferences. Each user_preferences entity may comprise an identifier of the preference (e.g., an integer, a string, or other identifier of the service constituting the preference) within a category included in the user_preferences entity (e.g., user 303). The user_preferences data may be provided to a hotel upon confirmation of an automatic offer or a manual offer by the user.

Moreover, each user may have a one-to-one relationship with an auth_tokens entity. Each auth_tokens entity may comprise a token or other authentication data that the user may use for authentication.

As further depicted in structure 300, each user 303 may include a user_perks entity that includes a selection of perks (services) input by the user. Accordingly, each user_perks entity may have a many-to-one relationship with the user entity and a many-to-one relationship with the perks entity of the hotel.

As further depicted in structure 300, each user request 305 may include a requests entity having a one-to-many relationship with messages entities and a many-to-one relationship with the hotel entity. The requests entity may comprise an indicator of a hotel and/or a location, a start date, an end date, a budget, and one or more services selected by the user inputting the request represented by the entity. In some embodiments, the services of the requests entity may be copies from the user_perks entities associated with the users entity representing the inputting user. Moreover, the requests entities may have a many-to-one relationship with a users entity of each user 303. Each messages entity may comprise any text from the user inputting the request represented by the linked requests entity.

As further depicted in structure 300, each automatic offer 307 may include an auto_offers entity having a one-to-many relationship with auto_offer_rooms entities, auto_offer_details entities, and auto_offer_perks entities. Each auto_offers entity may comprise a start date and an end date of the offer represented by the entity. As explained above, the auto_offers entities may have a many-to-one relationship with each requests entity of user request 305. Moreover, the auto_offers entities may have a many-to-one relationship with the hotel entity.

Each auto_offer_rooms entity may comprise an indicator of a room available for an offer represented by a linked auto_offers entity and a price associated with the room. Although not depicted in FIG. 3, the auto_offer_rooms entities may have a many-to-one relationship with each rooms entity of a hotel (e.g., hotel 301) providing the offer represented by the linked auto_offers entity. Each auto_offer_details entity may comprise an indicator of an upgrade (if applicable) provided in an offer represented by a linked auto_offers entity and a price associated with the upgrade. Each auto_offer_perks entity may comprise an indicator of a perk (i.e., a service) provided in an offer represented by a linked auto_offers entity and a price associated with the perk. In some embodiments, the entities representing automatic offer 307 may only be stored when automatic offer 307 is selected (and thus confirmed) by the user. Otherwise, automatic offer 307 may be temporarily generated for viewing by the user without being stored in structure 300.

As further depicted in structure 300, offers may be represented using an offers entity with a many-to-one relationship with the requests entities, the auto_offers entity, and a bookings entity (described below), as well as a one-to-many relationship with an offer_perks entity, an offer rooms entity. The offers may be similar to automatic offers but represent manual offers from a hotel. In some embodiments, the entities representing the offers may only be stored when a manual offer is selected (and thus confirmed) by the user. Otherwise, a manual offer may be temporarily generated for viewing by the user without being stored in structure 300.

As further depicted in structure 300, a bookings entity may have a one-to-many relationship with the users entities, the hotels entities, and the offers entities. Accordingly, bookings may comprise entities representing confirmed bookings (resulting from confirmed offers) between users and hotels. The bookings entities may be updated upon selection of a manual offer and/or of an automatic offer by a user.

One of ordinary skill will understand that additional and/or alternative entities may be added to structure 300 while retaining the rule-based nature of the database represented by structure 300 and the functionality of the rule-based database described herein. Moreover, although depicted as using a relational structure, other structures may be used based on the scheme depicted in FIG. 3. For example, as explained above, an object-oriented database, a graphical database, a hierarchical database, or the like may be used in lieu of the relational structure depicted in FIG. 3 while retaining the rule-based nature of the database represented by structure 300 and the functionality of the rule-based database described herein.

FIG. 4 depicts an example method 400 for constructing and indexing a rule-based offer database. Method 400 may be implemented using one or more processors (e.g., processor 1501 of FIG. 15).

At step 401, the one or more processors may receive a date rule specifying a start date and an end date. For example, as explained above, a user may input the date rule using one or more GUI elements, such as date selectors (e.g., selectors 1001 and 1003 of GUI 1000 of FIG. 10).

At step 403, the one or more processors may receive a rate rule relating one or more room types to one or more rates. For example, as explained above, the user may input the rate rule using one or more GUI elements, such as text boxes (e.g., text boxes 1005 and 1007 of GUI 1000 of FIG. 10).

In some embodiments, the one or more room types may comprise a first room type and a second room type, the second room type having a higher category than the first room type. As explained above, a higher category may refer to a larger square footage, additional beds, and/or additional amenities such as a kitchenette, a minibar, or the like.

In such embodiments, the one or more processors may receive an upgrade rule relating the second room type to a price associated with the first room type and link the date rule to the upgrade rule. The first room type may represent the room type having an associate price immediately below, in a ranked order, an associated price of the second room type. Accordingly, additional room types may be included having associated prices higher than the second room type and lower than the first room type. The user may input the upgrade rule using one or more GUI elements, such as a selectable graphic (e.g., graphic 1101 of FIG. 11A) and text boxes associated therewith (not shown in FIG. 11A) for receiving a minimum length of stay. For example, the “upgrade rule” may comprise a data structure that associates the second room type (e.g., an indicator of a type from a class or array defining possible room types) with the minimum length of stay (e.g., an integer representing a number of days) at which the second room type becomes available for the price associated with the first room type.

At step 405, the one or more processors may receive a services rule relating one or more services to one or more prices. For example, as explained above, the user may input the services rule using one or more GUI elements, such as selectable graphics (e.g., graphics 1101, 1103, 1105, 1107, 1109, 1111, 1113, 1115, and 1117 of GUI 1100 of FIG. 11A) and text boxes associated therewith (e.g., text box 1153 associated with graphic 1103′ of GUI 1100′ of FIG. 11B or text box 1159 associated with graphic 1119 of GUI 1100″ FIG. 11C).

At step 407, the one or more processors may receive one or more conditions for coupling to the services rules. For example, as explained above, the user may input the one or more conditions using one or more GUI elements, such as selectors (e.g., selectors 1009, 1011, 1013, and 1015 of GUI 1000 of FIG. 10 or selector 1169 associated with graphic 1119 of GUI 1100″ FIG. 11C).

In some embodiments, the one or more conditions may relate minimum lengths of stays to a number of services. In such embodiments, the one or more conditions may be input using selectors 1009, 1011, 1013, and 1015 of GUI 1000. Additionally or alternatively, the one or more conditions may comprise a minimum length of stay required for at least one of the services. In such embodiments, the one or more conditions may be input using text boxes and/or selectors coupled to selectable graphics, such as selector 1169 coupled to graphic 1119 of FIG. 11C.

At step 409, the one or more processors may construct the rule-based offer database. For example, as explained above, the one or more processors may store the received date rule, rate rule, services rule, and one or more conditions in a database and form associations (or links) between the received date rule, rate rule, services rule, and one or more conditions to allow for generating automatic offers using the database.

In one embodiment, the one or more processors may construct the database by associating the one or more conditions with the services rule to generate one or more service entities (e.g., the “perks” entity of FIG. 3), linking the date rule to the one or more service entities (e.g., storing the date rule and associating the “perks” entity with the stored date rule), associating rates of the rate rule to room types of the rate rule to generate one or more room entities (e.g., the “rooms” entity of FIG. 3), linking the date rule to the one or more room entities (e.g., associating the stored date rules with the one or more “rooms” entities), and indexing the date rule for offer generation (e.g., using the date rule to initially process any requests from the user input represented by the “requests” entity of FIG. 3). In some embodiments, the room entities and the services entities may be linked (e.g., either directly or through another entity such as the “hotels” entity).

Method 400 may further include additional steps. For example, method 400 may further include receiving a stock rule relating the one or more room types to one or more amounts of rooms and associating amounts of the stock rule to the one or more room entities. In such embodiments, the “stock rule” may comprise a data structure that associates the one or more room types (e.g., indicators of types from a class or array defining possible room types) with a number of available rooms of each type (e.g., an integer representing a number of rooms). The number of available rooms in the stock rule may comprise a portion of the “rooms” entity of FIG. 3.

Additionally or alternatively, method 400 may further include receiving a capacity rule relating the one or more room types to one or more capacities and associating capacities of the stock rule to the one or more room entities. In such embodiments, the “capacity rule” may comprise a data structure that associates the one or more room types (e.g., indicators of types from a class or array defining possible room types) with a number of persons that may be accommodated in the room type (e.g., an integer representing a number of persons; a plurality of integers representing a number of adults and/or children, respectively; or the like). The number of persons in the capacity rule may comprise a portion of the “rooms” entity of FIG. 3.

Additionally or alternatively, method 400 may further include receiving a blackout rule specifying one or more dates and adjusting the date rule to exclude the one or more dates. For example, the blackout dates may be incorporated into the stored date rule. Additionally or alternatively, the blackout rule may relate one or more dates to the one or more room types. Accordingly, the one or more processors may associate dates of the blackout rule to the one or more room entities. For example, the blackout dates may be incorporated into the “rooms” entity of FIG. 3.

FIG. 5 depicts an example method 500 for generating personalized search results using a rule-based offer database. Method 500 may be implemented using one or more processors (e.g., processor 1501 of FIG. 15).

At step 501, the one or more processors may receive one or more favorite services from a user. For example, as explained above, a user may input the favorite rule using one or more GUI elements, such as selectable graphics (e.g., graphics 601, 603, 605, 607, 609, 611, 613, 615, 617, and 619 of GUI 600 of FIG. 6).

At step 503, the one or more processors may receive a start date and an end date from the user. For example, as explained above, the user may input the start date and the end using one or more GUI elements, such as date selectors (e.g., date selector 703 and date selector 705 of GUI 700 of FIG. 7).

In some embodiments, as explained above, the start date may not be farther in time than a maximum date. Additionally or alternatively, a number of days between the start date and the end date may not exceed a threshold.

At step 505, the one or more processors may receive a capacity and a number of rooms from the user. For example, as explained above, the user may input the capacity and the number of rooms using one or more GUI elements, such as selectors and/or text boxes (e.g., selector 707 of GUI 700 of FIG. 7).

At step 507, the one or more processors may select stock using the rule-based offer database. For example, as explained above, the one or more processors may select stock using the rule-based offer database by mapping the start date and the end date onto one or more date rules including both the start date and the end date and mapping the capacity and the number of rooms onto one or more rooms. Accordingly, the one or more processors may run the start date and the end date against an index to determine one or more automatic offers that are valid between the start date and the end date. The one or more processors may further run the number of rooms against an index to determine one or more “rooms” entities having sufficient availability to satisfy the number of rooms and are linked to each automatic offer that satisfies the date rule. Additionally, the one or more processors may run the capacity against an index to determine which of the one or more “rooms” entities that satisfies the capacity and filter the one or more “rooms” entities accordingly.

At step 509, the one or more processors may select services using the rule-based offer database. For example, as explained above, the one or more processors may select services using the rule-based offer database by mapping the one or more favorite services onto one or more services of the rule-based offer database, selecting a subset of the one or more services for which one or more conditions are met, and ranking the subset based on a priority input by the user. Accordingly, the one or more processors may run the one or more favorite services against an index to determine one or more “perks” entities of FIG. 3 that match at least one of the favorite services. The one or more processors may iteratively determine matching services to identify a maximum number of matching services. The one or more processors may further determine whether any conditions included in the one or more “perks” entities, such as a minimum length of stay, are satisfied and filtered out any “perks” entities for which the conditions are not satisfied. The one or more processors may then rank the remaining “perks” entities based on a priority of the one or more favorite services.

At step 511, the one or more processors may generate one or more offers that match the one or more rooms with the ranked services. For example, the one or more processors may bundle the filtered one or more “rooms” entities with corresponding “perks” entities based on the rankings. In some embodiments, if any resulting offers have fewer “perks” entities than a threshold number of services, the one or more processors may select additional “perks” entities to include in the offer. The selection may be based on a determination of additional “perks” entities that are similar to the one or more favorite services, e.g., based on one or more stored rules and/or a lookup table of related services.

In addition to or in lieu of generating automatic offers, the one or more processors may generate an offer request including the one or more favorite services, the start date, the end date, the capacity, and the number of rooms, and transmit the offer request to one or more hotels. For example, the offer request may comprise an email message including the one or more favorite services, the start date, the end date, the capacity, and the number of rooms.

Method 500 may further include additional steps. For example, method 500 may further include calculating disparities between prices of the one or more rooms and the ranked services and rates retrieved from the rule-based offer database. As explained above, a disparity for an offer may comprise a total of prices of the services included in the offer. In offers having a room upgrade is offered, the disparity may further include a difference between a price of the upgraded room in the offer and a price of the base room in the offer.

In such embodiments, method 500 may further include generating a user interface with a ranked list of the generated offers that allows the user to select an offer from the generated offers. For example, GUI 900 of FIG. 9 depicts an example of such a user interface.

In any of the embodiments described above, method 500 may include receiving a budget from the user. For example, as explained above, a user may input the favorite rule using one or more GUI elements, such as a text box and/or a selector (e.g., selector 709 of GUI 700 of FIG. 7). In such embodiments, selecting the stock may further comprise selecting a subset of the one or more rooms having prices within the received budget. For example, the one or more processors may further filter the one or more “rooms” entities based on whether prices included in the entities fall within the received budget. Alternatively, the one or more processors may account for the budget when determining a matching percentage for each offer, as described above.

In any of the embodiments described above, method 500 may include receiving a location from the user. In such embodiments, selecting the stock may further comprise selecting a subset of the one or more rooms associated with hotels in a vicinity of the location. The vicinity of the location may comprise an area of a city of the location and areas of cities sharing a border with the city of the location.

Additionally or alternatively, method 500 may include receiving a hotel name from the user and selecting coordinates associated with the hotel name using a hotel database. In such embodiments, selecting the stock may further comprise selecting a subset of the one or more rooms associated with the selected hotel address and within a vicinity of the coordinates. The vicinity of the coordinates may comprise an area of a city of the coordinates and areas of cities sharing a border with the city of the coordinates. Moreover, in such embodiments, method 500 may include generating an offer request including the one or more favorite, the start date, the end date, and the capacity, and the number of rooms, and transmitting the offer request to a hotel selected by the user in addition to or in lieu of step 511.

FIGS. 6-9 depict a series of graphical user interfaces (GUIs) that may be used by a user to search a rule-based offer database and receive personalized offers therefrom.

FIG. 6 depicts an example GUI 600 for displaying a plurality of graphics being associated with services and being selectable. For example, GUI 600 may be generated by one or more processors (e.g., processor 1501 of FIG. 15) and transmitted to a device associated with a user (e.g., device 1400 of FIGS. 14A and 14B). GUI 600 may be used to receive one or more favorite services from a user (e.g., as explained above with respect to step 501 of FIG. 5).

As depicted in FIG. 6, GUI 600 may include a plurality of selectable graphics, e.g., graphics 601, 603, 605, 607, 609, 611, 613, 615, 617, and 619. As further shown in the example of FIG. 6, graphics 601, 603, 605, 607, and 609 have been selected by a user of GUI 600. It is to be understood that the graphics are also de-selectable as well as selectable.

In some embodiments, the one or more processors generating GUI 600 and receiving input therefrom may cap the number of graphics that may be selected by the user. For example, the cap may comprise one, two, three, four, five, or the like graphics. In such embodiments, the one or more processors may generate an error message when an additional graphic beyond the cap is selected. Alternatively, the one or more processors may automatically de-select a previously selected graphic in order to allow the additional graphic to be selected without exceeding the cap. The one or more processors may choose the previously selected graphic to be de-selected based on a first-in-first-out (FIFO) scheme, a first-in-last-out (FILO) scheme, or the like.

Additionally or alternatively, the one or more processors may require a minimum number of graphics to be selected. In embodiments having a cap, the minimum may comprise the same number as the cap or a smaller number than the cap. To effect the minimum, the one or more processors may de-activate confirmation button 621 (described below) until the minimum is reached and/or may generate an error message if the user attempts to submit the selections without reaching the minimum.

As further depicted in the example of FIG. 6, graphics 601, 603, 605, 607, and 609 have been ranked by the user, in that respective order. The ranking may be based on the order in which the user selected the graphics. In such embodiments, any de-selection described above may include adjusting the ranking accordingly. Alternatively, an additional input element (not shown) such as a drop down menu or a selector may be used to allow the user to rank the selected graphics.

Example GUI 600 further includes a confirmation button 621. Accordingly, the one or more processors generating GUI 600 and receiving input therefrom may receive the selected services in response to the user's interaction with button 621 (e.g., via a mouse click, a tap, or the like).

FIG. 7 depicts an example GUI 700 having a text box for entry of a location or hotel name, date selectors for entry of start and end dates, and a selector for capacity and number of rooms. For example, GUI 700 may be generated by one or more processors (e.g., processor 1501 of FIG. 15) and transmitted to a device associated with a user (e.g., device 1400 of FIGS. 14A and 14B). GUI 700 may be used to receive a start date, an end date, a capacity, and a number of rooms from a user (e.g., as explained above with respect to steps 503 and 505 of FIG. 5).

In some embodiments, GUI 700 may be generated and transmitted in response to receiving input of services from GUI 600, described above. Accordingly, GUI 700 may further include a representation 711 (e.g., a plurality of graphics and/or text, as depicted in FIG. 7) of the services selected using GUI 600 as well as a link 715 to return to GUI 600.

As depicted in FIG. 7, GUI 700 may include a date selector 703 for entry of the start date and a date selector 705 for entry of the end date. In some embodiments, the one or more processors generating GUI 700 and receiving input therefrom may apply one or more limitations to the start date and the end date. For example, the one or more processors may limit date selector 703 to dates that are at least a threshold number of days from a current system date (e.g., only allowing searches for offers beginning tomorrow, at least two days later, at least a week later, or the like) and/or no more than a threshold number of days from a current system date (e.g., only allowing searches for offers beginning no more than two weeks from the current date, no more than one month from the current date, or the like). Additionally or alternatively, the one or more processors may limit date selector 705 to dates that are no more than a threshold number of days from a current system date (e.g., only allowing searches for offers ending no more than two weeks from the current date, no more than one month from the current date, or the like) and/or no more than a threshold number of days from the start date of date selector 703 (e.g., only allowing searches for offers having a duration of stay two weeks or less, one month or less, or the like). In the latter embodiments, the one or more processor may de-activate date selector 705 until a start date is chosen using date selector 703.

As further shown in the example of FIG. 7, selector 707 may be used for entry of the capacity and the number of rooms. Additionally, in some embodiments, selector 709 may be used for entry of a budget. The budget may be used when searching the rule-based offer database and/or may be used when determining a matching percentage, as described above.

As shown in the example of FIG. 7, GUI 700 may further include a text box 701. Text box 701 may be used for entry of a location or a hotel name. Accordingly, offers from the rule-based offer database may only be included if they are within a vicinity of the location and/or a vicinity of the named hotel. As used herein, “vicinity” refers to any threshold distance around a geographic point, any predetermined geographic shape including the geographic point, an area of a city of the geographic point and areas of cities sharing a border with the city, or any other measure of an area surrounding the geographic point. Alternatively, each hotel may be assigned one or more tags associating the hotel with one or more cities such that the “vicinity” of a city comprises all hotels having the tag associated with the city.

In some embodiments, GUI 700 may further include a text box 717. Text box 717 may allow the user to indicate a special request to one or more hotels to which the user's request may be sent. In some embodiments, the special requests may be sent to one hotel at a time such that the user must select each hotel individually to send the special request. The one or more processors may send the request in addition to generating a query using the request to retrieve one or more personalized offers from the rule-based offer database. Generating the query may be performed in response to confirmation button 713.

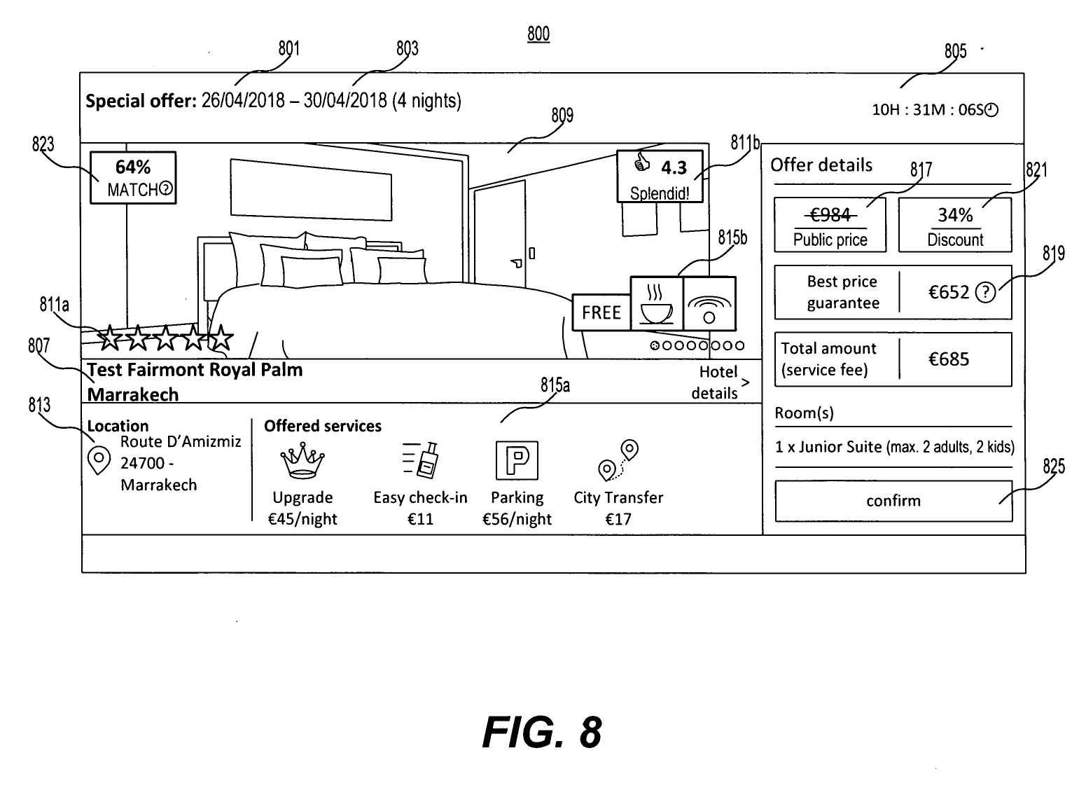

FIG. 8 depicts an example GUI 800 for displaying a personalized offer. For example, GUI 800 may be generated by one or more processors (e.g., processor 1501 of FIG. 15) and transmitted to a device associated with a user (e.g., device 1400 of FIGS. 14A and 14B). GUI 800 may be used to display a personalized offer to a user. The personalized offer may be displayed in response to its retrieval from the rule-based offer database (e.g., as explained above with respect to method 500 of FIG. 5). In some embodiments, GUI 800 may comprise a component of a list of offers rather than a standalone GUI, as explained below with respect to FIG. 9.

As shown in the example of FIG. 8, GUI 800 may include the start date 801 and end date 803 of the offer. For example, start date 801 and end date 803 may match a start date and an end date provided by the user. GUI 800 may further include an indicator 805 of an expiry time of the offer. For example, the expiry time may correspond to an expiry set by a hotel providing the offer. Alternatively, the expiry time may comprise a set time from when the user was provided the offer, such as 24 hours, 12 hours, 10 hours, or the like.

As further shown in the example of FIG. 8, GUI 800 may include details regarding the hotel, such as name 807, one or more images provided by the hotel (e.g., image 809), an indicator 811a of a category of the hotel (e.g., a rating issued by an agency such as the American Automobile Association (AAA) or the European Hotelstars Union). Additionally or alternatively, GUI 800 may include an indicator 811b of a rating of the hotel, e.g., aggregated from one or more review website such as TripAdvisor® or Hotels.com®, or the like and/or aggregated from users of GUI 800. Additionally, GUI 800 may include a physical address 813 of the hotel, or the like. GUI 800 may further include details regarding the offer. For example, GUI 800 may include a list of services 815a included in the offer as well as a list of services 815b provided by the hotel for free by default. In the example of FIG. 8, the hotel provides breakfast and Wi-Fi for free but then further includes an upgrade, easy check-in, parking, and a city transfer as a part of the automatic offer. In the example of FIG. 8, list 815a also includes prices of the included services such that the user viewing GUI 800 can see the retail cost of the services included in the offer for free. Accordingly, the prices displayed on list 815a may comprise prices entered by the hotel, e.g., using GUI 1100, as described below.

List 815a may alternatively include the value of each service included in the offer. The value of each service may be determined based on an average of costs of the service in all hotels in the same city and/or vicinity of the city, as explained above. Accordingly, based on prices input for the associated service by each hotel in the same city and/or vicinity, the value of each service may be determined by averaging the prices. The system may determine value of services by checking which services has the highest minimum stay condition and assign such services based on descending order of determined value. Alternatively, the cash value of each service may be displayed, which may be determined by multiplying the price (or average value) of each service by the number of nights, number of rooms, and/or number of persons included in the offer.

Further details of the offer may include an indicator 817 of the full retail cost of the room and services included in the offer, an indicator 819 of the price of the offer, and an indicator 821 of the difference between the price of the offer and the full retail price (and/or the difference between the price of the offer and the value of the services included in the offer, as explained above). Furthermore, a matching indicator 823 may alert the user as to the degree of match between the offer and a query submitted by the user. For example, a matching percentage (or other score) may be based, at least in part, on a relation between a number of the services included in the offer and a number of days between the start date and the end date and/or on an overlap between the services included in the offer and selected services input by the user. Accordingly, offers with a greater number of services included and/or services more closely matching the selected services may receive a higher matching percentage. Additionally or alternatively, the matching score may be based on a distance between a budget input by the user and the price of the offer. Accordingly, offers with a price within the budget may receive a higher matching percentage than offers with a price that is 50 or more euros above the budget. In some embodiments, offers having a price below the budget may receive a lowing matching score (due to the distance) or a higher matching score (indicating that the offer is a bargain).

Confirmation button 825 may allow the user to select the offer for finalization. For example, confirmation button 825 may result in a GUI (not shown) that facilitates payment for the offer. Confirmation button 825 may also trigger a reservation on a system associated with the hotel.

FIG. 9 depicts an example GUI 900 for displaying a ranked list of personalized offers. For example, GUI 900 may be generated by one or more processors (e.g., processor 1501 of FIG. 15) and transmitted to a device associated with a user (e.g., device 1400 of FIGS. 14A and 14B). GUI 900 may include a plurality of GUIs similar to GUI 800 in a list format. The list may be displayed in response to retrieval of offers from the rule-based offer database (e.g., as explained above with respect to method 500 of FIG. 5).

Accordingly, as depicted in FIG. 9, offer 910 may be displayed in a list with offer 950. Each offer in the list may include means for selecting the offer. For example, offer 910 includes confirmation button 911. Accordingly, by interacting with button 911, a user of GUI 900 may select offer 910. As explained above, confirmation button 911 may result in a GUI (not shown) that facilitates payment for offer 910 and/or may trigger a reservation on a system associated with the hotel providing offer 910.

FIGS. 10-13 depict a series of graphical user interfaces (GUIs) that may be used by a user to populate a rule-based offer database.

FIG. 10 depicts an example GUI 1000 having date selectors for entry of start and end dates and text boxes for entry of room rates. For example, GUI 1000 may be generated by one or more processors (e.g., processor 1501 of FIG. 15) and transmitted to a device associated with a hotel (e.g., device 1400 of FIGS. 14A and 14B and/or device 1450 of FIG. 14C). GUI 1000 may be used to receive a date rule and a rate rule from the hotel (e.g., as explained above with respect to steps 401 and 403 of FIG. 4).

As shown in FIG. 10, GUI 1000 may include a date selector 1001 for entry of the start date and a date selector 1003 for entry of the end date. In some embodiments, the one or more processors generating GUI 1000 and receiving input therefrom may apply one or more limitations to the start date and the end date. For example, the one or more processors may limit date selector 1001 to dates that are at least a threshold number of days from a current system date (e.g., only allowing creation of offers beginning tomorrow, at least two days later, at least a week later, or the like) and/or no more than a threshold number of days from a current system date (e.g., only creation of offers beginning no more than two weeks from the current date, no more than one month from the current date, or the like). Additionally or alternatively, the one or more processors may limit date selector 1003 to dates that are no more than a threshold number of days from a current system date (e.g., requiring that created offers end no more than two weeks from the current date, no more than one month from the current date, or the like) and/or no more than a threshold number of days from the start date of date selector 1003 (e.g., only allowing creation of offers having a duration of two weeks or less, one month or less, or the like). In the latter embodiments, the one or more processor may de-activate date selector 1003 until a start date is chosen using date selector 1001.

As further shown in the example of FIG. 10, text box 1005 may be used for entry of a rate associated with a first type of room, and text box 1007 may be used for entry of a rate associated with a second type of room. For example, all room types previously input by the hotel may be displayed such that the room types are selectable for inclusion in the automatic offer. In such an example, and as shown in FIG. 10, the room types may be displayed in ascending price order. In some embodiments, as explained above, the second room type may have a higher category than the first room type. A higher category may refer to a larger square footage, additional beds, and/or additional amenities such as a kitchenette, a minibar, or the like. The types of rooms may be categorized by capacity and/or by price (as shown in FIG. 10), which may be edited by a user of GUI 1000. Although described above with two room types, any number of room types may be used. For example, a single room type may be used (and, thus, one text box in GUI 1000) or more than two room types may be used (each with a corresponding text box in GUI 1000).

GUI 1000 may also include selectors 1009, 1011, 1013, and 1015 for receiving input of one or more conditions for pairing to services provided in an offer created by the input to GUI 1000. As shown in FIG. 10, each selector may allow the hotel to pair a length of stay with a number of offered services. Accordingly, in the example of FIG. 10, a total of two services is paired with stays of one day long, a total of three services is paired with stays of two days long, a total of four services is paired with stays of three days long, and a total of five services is paired with stays of four or more days long. GUI 1000 may include an indicator 1019 of the average number of services per length of stay offered by all hotels in the same city and/or vicinity.

Example GUI 1000 further includes a confirmation button 1017. Accordingly, the one or more processors generating GUI 1000 and receiving input therefrom may receive the date rule, the rate rule, the one or more conditions in response to the user's interaction with button 1017 (e.g., via a mouse click, a tap, or the like).

FIG. 11A depicts an example GUI 1100 for displaying a plurality of graphics being associated with services and being selectable. For example, GUI 1100 may be generated by one or more processors (e.g., processor 1501 of FIG. 15) and transmitted to a device associated with a hotel (e.g., device 1400 of FIGS. 14A and 14B). GUI 1100 may be used to receive a services rule and one or more conditions from the hotel (e.g., as explained above with respect to steps 405 and 407 of FIG. 4). In some embodiments, GUI 1100 may be generated and transmitted in response to receiving input from GUI 1000, described above. In other embodiments, although depicted separately, GUI 1100 may represent a lower portion of GUI 1000 such that GUI 1100 is visible when the user of GUI 1000 scrolls down.

As show in FIG. 11A, GUI 1100 may include selectable graphics (e.g., graphics 1101, 1103, 1105, 1107, 1109, 1111, 1113, 1115, 1117, etc.) associated with a plurality of services. Accordingly, the hotel may use the selectable graphics to choose one or more services available with the offer generated from the input to GUI 1100 (optionally used in combination with the input to GUI 1000).

Example GUI 1100 further includes a confirmation button 1119. Accordingly, the one or more processors generating GUI 1100 and receiving input therefrom may receive the services rule and the one or more conditions in response to the user's interaction with button 1119 (e.g., via a mouse click, a tap, or the like).

FIG. 11B depicts an example GUI 1100′ where a graphic displays a corresponding text box for entry of a price in response to selection of a graphic. For example, GUI 1100′ may be generated by one or more processors (e.g., processor 1501 of FIG. 15) and transmitted to a device associated with a hotel (e.g., device 1400 of FIGS. 14A and 14B). GUI 1100′ may be used to receive a services rule and one or more conditions from the hotel (e.g., as explained above with respect to steps 405 and 407 of FIG. 4). In some embodiments, GUI 1100′ may represent GUI 1100 after graphic 1103 is selected (shown as 1103′ in FIG. 11B), described above.

As shown in the example of GUI 1100′, a text box 1153 is displayed in response to selection of graphic 1103′ such that text box 1153 receives a price to associate with the service associated with graphic 1103′. The price may represent a price per room once, per person once, per room per night and per person per night, which may be used to calculate the value of the service within an automatic offer depending on the length of stay, number of rooms, and capacity included in the automatic offer. Additionally, as explained above, the entered prices may be averaged within the same city and/or vicinity in order to determine the value of the service. In such an alternative, the average price per room per person per night may be determined, which may then be used to calculate the value of the service within an automatic offer depending on the length of stay, number of rooms, and capacity included in the automatic offer, as explained above. In some embodiments, GUI 1100′ may display the value (average price) of the service in addition to providing text box 1153.

FIG. 11C depicts an example GUI 1100″ where a graphic displays a corresponding text box for entry of a price in response to selection of a graphic. For example, GUI 1100″ may be generated by one or more processors (e.g., processor 1501 of FIG. 15) and transmitted to a device associated with a hotel (e.g., device 1400 of FIGS. 14A and 14B). GUI 1100″ may be used to receive a services rule and one or more conditions from the hotel (e.g., as explained above with respect to steps 405 and 407 of FIG. 4). In some embodiments, GUI 1100″ may represent GUI 1100 after graphic 1119 is selected.

As shown in the example of GUI 1100″, a text box 1159 is displayed in response to selection of graphic 1119 such that text box 1159 receives a price to associate with the service associated with graphic 1119. In addition, a selector 1169 is displayed in response to selection of graphic 1119 such that selector 1169 receives a minimum stay length to associated with the service associated with graphic 1119.

FIG. 12A depicts an example GUI 1200 for displaying a calendar displaying a start date, an end date, and one or more room rates, along with a text box for entry of stock. For example, GUI 1200 may be generated by one or more processors (e.g., processor 1501 of FIG. 15) and transmitted to a device associated with a hotel (e.g., device 1400 of FIGS. 14A and 14B). GUI 1200 may be used to receive a stock rule and/or a blackout rule from the hotel (e.g., as explained above with respect to FIG. 4). In some embodiments, GUI 1200 may be generated and transmitted in response to receiving input from GUI 1100, described above.

As shown in FIG. 12A, GUI 1200 may include a calendar 1205 displaying the start date 1205a and the end date 1205b (e.g., having been received using GUI 1000 of FIG. 10). The calendar also displays room rates (displayed next to “R” on each date, such as start date 1205a and end date 1205b) and includes a text box 1207 for entry of stock on a selected day. In an alternative embodiment not shown, each day (e.g., start date 1205a and end date 1205b) may include a text box for entry of stock for that day.

As further shown in FIG. 12A, GUI 1200 may include radio buttons 1209a and 1209b. Radio buttons 1209a and 1209b may be used to input the blackout rule. For example, radio button 1209b may be used to mark a day on calendar 1205 as excluded from the offer generated based on the input to GUI 1200. In some embodiments, rather than exclude the day directly, radio button 1209b may automatically set stock on that day to zero (e.g., by setting text box 1207 to zero). Conversely, radio button 1209a may be used to mark a day on calendar 1205 as included in the offer.

Example GUI 1200 further includes a confirmation button 1211. Accordingly, the one or more processors generating GUI 1200 and receiving input therefrom may receive the stock rule and/or the blackout rule in response to the user's interaction with button 1211 (e.g., via a mouse click, a tap, or the like).

FIG. 12B depicts an example GUI 1250 for displaying a calendar displaying a start date, an end date, and one or more room rates, along with a text box for entry of rates. For example, GUI 1250 may be generated by one or more processors (e.g., processor 1501 of FIG. 15) and transmitted to a device associated with a hotel (e.g., device 1400 of FIGS. 14A and 14B). GUI 1250 may be used to receive a rate rule from the hotel (e.g., as explained above with respect to FIG. 4). In some embodiments, GUI 1250 may be generated and transmitted in response to receiving input from GUI 1100, described above. Although depicted separately, GUI 1250 of FIG. 12B may represent a modification to GUI 1200 of FIG. 12A when radio button 1203 is selected rather than radio button 1201.

As shown in FIG. 12B, GUI 1250 may include a calendar 1205 displaying the start date 1205a and the end date 1205b (e.g., having been received using GUI 1000 of FIG. 10). The calendar also displays room rates (displayed next to “R” on each date, such as start date 1205a and end date 1205b) and includes a text box 120T for entry of a room rate on a selected day. In an alternative embodiment not shown, each day (e.g., start date 1205a and end date 1205b) may include a text box for entry of a room rate for that day. Accordingly, different versions of GUI 1250 may be used for each room type that may have associated rates. In an alternative embodiment, a plurality of room rates may be displayed on each day on calendar 1205 such that multiple rates may be set for each day on the same calendar.

Example GUI 1250 further includes a confirmation button 1259. Accordingly, the one or more processors generating GUI 1259 and receiving input therefrom may receive the rate rule in response to the user's interaction with button 1259 (e.g., via a mouse click, a tap, or the like).

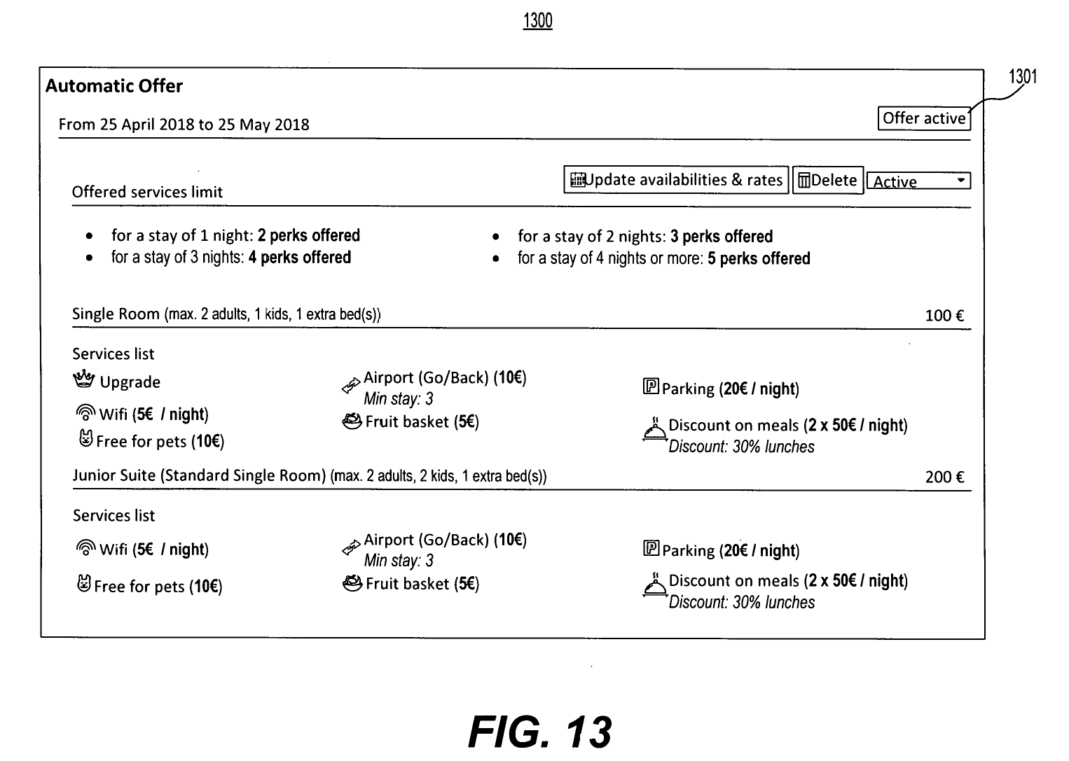

FIG. 13 depicts an example GUI 1300 for viewing and editing a portion of a rule-based offer database. For example, GUI 1300 may be generated by one or more processors (e.g., processor 1501 of FIG. 15) and transmitted to a device associated with a hotel (e.g., device 1400 of FIGS. 14A and 14B). GUI 1300 may display details of an offer created using GUIs 1000, 1100, 1200, 1250, or any combination thereof. Accordingly, GUI 1300 may be generated and transmitted in response to receiving input from GUIs 1000, 1100, 1200, 1250, or any combination thereof, described above.

Example GUI 1300 further includes a confirmation button 1301. Accordingly, the one or more processors generating GUI 1300 may activate the offer whose details are displayed on GUI 1300 in response to the user's interaction with button 1301 (e.g., via a mouse click, a tap, or the like).

FIG. 14A is a depiction of exemplary device 1400 for use in generating a rule-based offer database and/or receive personalized offers from a rule-based offer database. As depicted in FIG. 14A, device 1400 may comprise a smartphone. Device 1400 may have a screen 1401. For example, screen 1401 may display one or more GUIs (e.g., GUIs 600-900 of FIGS. 6-9) that allow a user to receive and select personalized offers using device 1400 and/or may display one or more GUIs (e.g., GUIs 1000-1300 of FIGS. 10-13) that allow a user to generate a rule-based offer database using device 1400. In certain aspects, screen 1401 may comprise a touchscreen to facilitate use of the one or more GUIs.

As further depicted in FIG. 14A, device 1400 may have one or more buttons, e.g., buttons 1403a and 1403b. For example, buttons 1403a and 1403b may facilitate use of one or more GUIs displayed on screen 1401.

FIG. 14B is a side view of device 1400 of FIG. 14A. As depicted in FIG. 14B, device 1400 may have at least one processor 1405. For example, at least one processor 1405 may comprise a system-on-a-chip (SOC) adapted for use in a portable device, such as device 1400. Alternatively or concurrently, at least one processor 1405 may comprise any other type(s) of processor.

As further depicted in FIG. 14B, device 1400 may have one or more memories, e.g., memories 1407a and 1407b. In certain aspects, some of the one or more memories, e.g., memory 1407a, may comprise a volatile memory. In such aspects, memory 1407a, for example, may store one or more applications (or “apps”) for execution on at least one processor 1405. For example, an app may include an operating system for device 1400 and/or an app for executing method 500 of FIG. 5. In addition, memory 1407a may store data generated by, associated with, or otherwise unrelated to an app in memory 1407a.

Alternatively or concurrently, some of the one or more memories, e.g., memory 1407b, may comprise a non-volatile memory. In such aspects, memory 1407b, for example, may store one or more applications (or “apps”) for execution on at least one processor 1405. For example, as discussed above, an app may include an operating system for device 1400 and/or an app for executing method 400 of FIG. 4 and/or method 500 of FIG. 5. In addition, memory 1407b may store data generated by, associated with, or otherwise unrelated to an app in memory 1407b. Furthermore, memory 1407b may include a pagefile, swap partition, or other allocation of storage to allow for the use of memory 1407b as a substitute for a volatile memory if, for example, memory 1407a is full or nearing capacity.

Although depicted as a smart phone, device 1400 may alternatively comprise a tablet or other computing device having similar components.

FIG. 14C is a depiction of exemplary device 1450 for use in generating a rule-based offer database and/or receive personalized offers from a rule-based offer database. As depicted in FIG. 14C, device 1450 may comprise a desktop computer.

As depicted in FIG. 14C, device 1450 may include at least one processor (e.g., processor 1453) and at least one memory (e.g., memories 1455a and 1455b).

Processor 1453 may comprise a central processing unit (CPU), a graphics processing unit (GPU), or other similar circuitry capable of performing one or more operations on a data stream. Processor 1453 may be configured to execute instructions that may, for example, be stored on one or more of memories 1455a and 1445b.

Memories 1455a and 1455b may be volatile memory (such as RAM or the like) and/or non-volatile memory (such as flash memory, a hard disk drive, or the like). As explained above, memories 1455a and 1455b may store instructions for execution by processor 503. For example, memory 1455a and/or memory 1455b may store one or more applications (or “apps”) for execution on at least one processor 1455. For example, as discussed above, an app may include an operating system for device 1450 and/or an app for executing method 400 of FIG. 4 and/or method 500 of FIG. 5.

As further depicted in FIG. 14C, device 1450 may include at least one network interface controller (NIC) (e.g., NIC 1457). NIC 1457 may be configured to facilitate communication over at least one computing network (e.g., network 1459, which is depicted in the example of FIG. 14C as the Internet). Communication functions may thus be facilitated through one or more NICs, which may be wireless and/or wired and may include an Ethernet port, radio frequency receivers and transmitters, and/or optical (e.g., infrared) receivers and transmitters. The specific design and implementation of the one or more NICs depend on the computing network 1459 over which device 1450 is intended to operate. For example, in some embodiments, device 1450 may include one or more wireless and/or wired NICs designed to operate over a GSM network, a GPRS network, an EDGE network, a Wi-Fi or WiMax network, and a Bluetooth® network. Alternatively or concurrently, device 1450 may include one or more wireless and/or wired NICs designed to operate over a TCP/IP network.

As depicted in FIG. 14C, device 1450 may include and/or be operably connected to one or more storage devices, e.g., storages 1451a and 1451b. Storage devices 1451a and 1451b may be volatile (such as RAM or the like) or non-volatile (such as flash memory, a hard disk drive, or the like).

Processor 1453, memories 1455a and 1455b, NIC 1457, and/or storage devices 1451a and 1451b may comprise separate components or may be integrated in one or more integrated circuits. The various components in device 1450 may be coupled by one or more communication buses or signal lines (not shown)/

Although depicted as a desktop computer, device 1450 may alternatively comprise a laptop or other computing device having similar components.

FIG. 15 is a depiction of exemplary server 1500 for use in creating and indexing a rule-based offer database as well as searching and using the same. As depicted in FIG. 15, server 1500 may have a processor 1501. Processor 1501 may comprise a single processor or a plurality of processors. As explained above, processor 1501 may comprise a CPU, a GPU, a reconfigurable array (e.g., an FPGA or other ASIC), or the like.

Processor 1501 may be in operable connection with a memory 1503, an input/output module 1505, and a network interface controller (NIC) 1507. Memory 1503 may comprise a single memory or a plurality of memories. In addition, memory 1503 may comprise volatile memory, non-volatile memory, or a combination thereof. As depicted in FIG. 15, memory 1503 may store one or more operating systems 1509 and one or more server applications 1511. In addition, memory 1503 may store data 1513 produced by, associated with, or otherwise unrelated to operating system 1509 and/or server applications 1511.

Input/output module 1505 may store and retrieve data from one or more databases 1515. For example, database(s) 1515 may include an audience database and/or user database consistent with the present disclosure. NIC 1507 may connect server 1500 to one or more computer networks. In the example of FIG. 15, NIC 1507 connects server 1500 to the Internet. Server 1500 may receive data and instructions over a network using NIC 1507 and may transmit data and instructions over a network using NIC 1507.

Processor 1501 may execute methods 400 and 500 of FIGS. 4 and 5, respectively. Accordingly, server 1500 may, for example, construct a rule-based offer database, index the database, search the database, and generate personalized offers therefrom.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system for constructing and indexing a rule-based offer database, comprising:
at least one memory storing instructions; and
at least one processor configured to execute the instructions to perform one or more operations, the operations comprising:
receiving a date rule specifying a start date and an end date;
receiving a rate rule relating one or more room types to one or more rates;
receiving a services rule relating one or more services to one or more prices;
receiving one or more conditions for coupling to the services rules; and
constructing the rule-based offer database by:
associating the one or more conditions with the services rule to generate one or more service entities,
linking the date rule to the one or more service entities,
associating rates of the rate rule to room types of the rate rule to generate one or more room entities,
linking the date rule to the one or more room entities,
linking the one or more service entities to the one or more room entities, and
indexing the date rule for offer generation.

2. The system of claim 1, wherein the operations further comprise:
receiving a stock rule relating the one or more room types to one or more amounts of rooms; and
associating amounts of the stock rule to the one or more room entities.

3. The system of claim 1, wherein the operations further comprise:
receiving a capacity rule relating the one or more room types to one or more capacities; and
associating capacities of the stock rule to the one or more room entities.

4. The system of claim 1, wherein the operations further comprise:
receiving a blackout rule specifying one or more dates; and
adjusting the date rule to exclude the one or more dates.

5. The system of claim 1, wherein the operations further comprise:
receiving a blackout rule relating one or more dates to the one or more room types; and
associating dates of the blackout rule to the one or more room entities.

6. The system of claim 1, wherein the one or more conditions relate minimum lengths of stays to a number of services.

7. The system of claim 1, wherein the one or more conditions comprise a minimum length of stay required for at least one of the services.

8. The system of claim 1, wherein:
the one or more room types comprise a first room type and a second room type, the second room type having a higher category than the first room type, and
the operations further comprise:
receiving an upgrade rule relating the second room type to a price associated with the first room type; and
linking the date rule to the upgrade rule.

9. A system for generating personalized search results using a rule-based offer database, comprising:
at least one memory storing instructions; and
at least one processor configured to execute the instructions to perform one or more operations, the operations comprising:
receiving one or more favorite services from a user;
receiving a start date and an end date from the user;
receiving a capacity and a number of rooms from the user;
selecting stock using the rule-based offer database by:
mapping the start date and the end date onto one or more date rules including both the start date and the end date, and
mapping the capacity and the number of rooms onto one or more rooms;
selecting services using the rule-based offer database by:
mapping the one or more favorite services onto one or more services of the rule-based offer database,
selecting a subset of the one or more services for which one or more conditions are met, and
ranking the subset based on a priority input by the user;
generating one or more offers that match the one or more rooms with the ranked services;
calculating disparities between prices of the one or more rooms and the ranked services and rates retrieved from the rule-based offer database; and
generating a user interface with a ranked list of the generated offers that allows the user to select an offer from the generated offers.

10. The system of claim 9, wherein the start date is not farther in time than a maximum date.

11. The system of claim 9, wherein a number of days between the start date and the end date does not exceed a threshold.

12. The system of claim 9, wherein the operations further comprise:
receiving a budget from the user,
wherein selecting the stock further comprises selecting a subset of the one or more rooms having prices within the received budget.

13. The system of claim 9, wherein the operations further comprise:
receiving a location from the user,
wherein selecting the stock further comprises selecting a subset of the one or more rooms associated with hotels in a vicinity of the location.

14. The system of claim 13, wherein the vicinity of the location comprises an area of a city of the location and areas of cities sharing a border with the city of the location.

15. The system of claim 9, wherein the operations further comprise:
receiving a hotel name from the user, and
selecting coordinates associated with the hotel name using a hotel database,
wherein selecting the stock further comprises selecting a subset of the one or more rooms associated with the selected hotel address and other rooms within a vicinity of the coordinates.

16. The system of claim 15, wherein the vicinity of the coordinates comprises an area of a city of the coordinates and areas of cities sharing a border with the city of the coordinates.

17. The system of claim 15, wherein the operations further comprise:
generating an offer request including the one or more favorite services, the start date, the end date, and the capacity, and the number of rooms, and
transmitting the offer request to a hotel selected by the user.

18. The system of claim 9, wherein:
the one or more rooms are within at least a first room type and a second room type, the second room type having a higher category than the first room type, and
the operations further comprise selecting one or more rooms in the second room type using an upgrade rule of the rule-based offer database; and
at least one of the generated one or more offers include the selected rooms in the second room type with the ranked services.

19. A non-transitory, computer-readable medium storing instructions that, when executed by at least one processor, cause the at least one processor to perform operations, the operations comprising:
generating a first user interface displaying a plurality of graphics, each graphic being associated with a service and being selectable;
transmitting the first user interface to a display associated with a user;
receiving, based on interaction with the first user interface, a selection of one or more services from the user;
in response to the selection of services, generating a second user interface having:
a text box for entry of a location or a hotel name,
a first date selector for entry of a start date,
a second date selector for entry of an end date,
a first selector for capacity, and
a second selector for a number of rooms;
transmitting the second user interface to the display;
receiving, based on interaction with the second user interface, the location, the start date, the end date, the capacity, and the number of rooms;
in response to receiving the location, the start date, and the end date, generating a query based on the selection, the location or the hotel name, the start date, and the end date;
retrieving a list of offers by running the query against a rule-based offer database;
generating a third user interface with the list of offers, each offer being selectable; and
transmitting the third user interface to the display.

20. The non-transitory, computer-readable medium of claim 19, wherein each selectable offer comprises an indicator of a retail price and an indicator of a discounted price.

21. The non-transitory, computer-readable medium of claim 20, wherein the retail price is based on a price of a room included in the offer and prices of one or more services included in the offer, and the discounted price is based on the price of the room.

22. The non-transitory, computer-readable medium of claim 19, wherein the third user interface includes the offers in a ranked order.

23. The non-transitory, computer-readable medium of claim 22, wherein the ranked order is based on a matching percentage.

24. The non-transitory, computer-readable medium of claim 23, wherein the operations further comprise calculating a matching percentage for each offer based, at least in part, on a relation between a number of the services included in the offer and a number of days between the start date and the end date and based on an overlap between the services included in the offer and the selected services.

25. The non-transitory, computer-readable medium of claim 23, wherein, when two or more offers in the list have the same matching percentage, the ranked order of the two or more offers is further based on a discounted price of the offers.

26. A non-transitory, computer-readable medium storing instructions that, when executed by at least one processor, cause the at least one processor to perform operations, the operations comprising:
generating a first user interface having:
a first date selector for entry of a start date,
a second date selector for entry of an end date,
one or more text boxes for entry of one or more room rates,
a plurality of graphics, each graphic being associated with a service and being selectable, wherein each graphic is configured to display a text box for entry of a price in response to selection of the graphic, and
a first confirmation button;
receiving the start date, the end date, the one or more room rates, and selected services with entered prices upon interaction with the first confirmation button;
in response to receiving the start date, the end date, the one or more room rates, and the selected services, generating a second user interface having:
at least one calendar displaying the start date, the end date, the one or more room rates,
at least one text box associated with the at least one calendar for entry of stock, and
a second confirmation button;
receiving the stock upon interaction with the second confirmation button; and
storing the start date, the end date, the one or more room rates, the stock, and the selected services with the entered prices in a rule-based offer database upon interaction with the second confirmation button.

27. The non-transitory, computer-readable medium of claim 26, wherein at least one of the plurality of graphics of the first user interface is further configured to display a menu for entry of a minimum length of stay in response to selection of the graphic.

28. The non-transitory, computer-readable medium of claim 27, wherein each graphic is further configured to remove the menu for entry of the minimum length in response to de-selection of the graphic.

29. The non-transitory, computer-readable medium of claim 26, wherein each graphic is further configured to remove the text box for entry of the price in response to de-selection of the graphic.

30. The non-transitory, computer-readable medium of claim 26, wherein the at least one calendar comprises a plurality of calendars, each calendar associated with a different room type.
